(19) United States
(12) Patent Application Publication
(10) Pub. No.: US 2026/0231276 A1
(43) Pub. Date: Aug. 6, 2026

(54) METHOD, USER EQUIPMENT AND ACCESS NETWORK NODE

(71) Applicant: NEC Corporation, Tokyo (JP)

(72) Inventors: Xuelong WANG, Guildford (GB); Yuhua CHEN, London (GB)

(73) Assignee: NEC Corporation, Tokyo (JP)

(21) Appl. No.: 19/149,865

(22) PCT Filed: Jan. 18, 2024
(86) PCT No.: PCT/JP2024/001354

§ 371 Date: Jul. 22, 2025

(30) Foreign Application Priority Data
Jan. 24, 2023 (GB) 2301029.1

(51) Int. Cl. H04W 76/27; H04L 1/1812; H04W 72/20

(52) U.S. Cl. CPC H04W 76/27; H04L 1/1812; H04W 72/20

(57) ABSTRACT

The present disclosure relates to A method of a user equipment, UE, the method comprising: receiving data of a multicast, from an access network node, using a repeat request process when the UE is in a radio resource control, RRC, connected state; transitioning into an RRC inactive state; and receiving the multicast, from the access network node, when the UE is in the RRC inactive state; wherein the UE uses the same repeat request process used to receive the multicast in the RRC connected state to receive data of the multicast when the UE is in the RRC inactive state.

### TECHNICAL FIELD

The present disclosure relates to a communication system.

### BACKGROUND ART

The disclosure has particular but not exclusive relevance to wireless communication systems and devices thereof operating according to the 3rd Generation Partnership Project (3GPP) standards or equivalents or derivatives thereof (including LTE-Advanced, Next Generation or 5G networks, future generations, and beyond). The disclosure has particular, but not exclusive, relevance to improvements related to multicast and broadcast (MBS) services.

Recent developments of the 3GPP standards are referred to as the Long-Term Evolution (LTE) of Evolved Packet Core (EPC) network and Evolved Universal Mobile Telecommunications Service (UMTS) Terrestrial Radio Access Network (E-UTRAN), also commonly referred as ‘4G’. In addition, the term ‘5G’ and ‘new radio’ (NR) refer to an evolving communication technology that is expected to support a variety of applications and services. Various details of 5G networks are described in, for example, the ‘NGMN 5G White Paper’ V1.0 by the Next Generation Mobile Networks (NGMN) Alliance, which document is available from https://www.ngmn.org/5g-white-paper.html. 3GPP intends to support 5G by way of the so-called 3GPP Next Generation (NextGen) radio access network (RAN) and the 3GPP NextGen core network.

Under the 3GPP standards, a NodeB (or an eNB in LTE, gNB in 5G) is the radio access network (RAN) node (or simply ‘access node’, ‘access network node’ or ‘base station’) via which communication devices (user equipment or ‘UE’) connect to a core network and communicate with other communication devices or remote servers. For simplicity, the present application will use the term RAN node or base station to refer to any such access nodes.

### SUMMARY OF INVENTION

### Technical Problem

Multicast and broadcast services (MBS) enable resource-efficient delivery of transmissions for groups of user equipment (UEs). For example, multicast communication to a group of UEs typically requires less overall bandwidth than a corresponding set of separate unicast (one to one) communications. Multicast transmissions to UEs that are in a radio resource control (RRC) connected state are able to provide higher quality of service (QoS) levels, improved reliability and better continuity than can be provided using broadcast. MBS may be used, for example, for public safety and mission critical applications, vehicle-to-everything (V2X) applications, or video delivery to a group of UEs. However, there is a need for improved MBS methods and procedures for providing improved reliability and resource efficiency. Moreover, for some MBS there may be service continuity requirements. For example, when the MSB is used for public safety applications, it is important that continuity of the MBS can be maintained even when a UE transitions from an RRC connected state to an RRC inactive state (which may occur, for example, due to a high RRC load).

More generally, there is a need for improved mechanisms and procedures for MBS. These mechanisms and procedures include, but are not limited to, procedures for maintaining continuity of an MBS when a UE transitions between an RRC connected state and an RRC inactive state.

### Solution to Problem

The disclosure aims to provide apparatus and methods that at least partially address the above needs and/or issues.

In a first aspect the disclosure provides a method of a user equipment (UE), the method comprising: receiving data of a multicast, from an access network node, using a repeat request process when the UE is in a radio resource control (RRC) connected state; transitioning into an RRC inactive state; and receiving data of the multicast, from the access network node, when the UE is in the RRC inactive state; wherein the UE uses the same repeat request process used to receive data of the multicast in the RRC connected state to receive data of the multicast when the UE is in the RRC inactive state.

The UE may maintain received data of the multicast in a buffer associated with the repeat request process during a transition from the RRC connected state to the RRC inactive state.

The method may further comprise receiving, from the access network node, downlink control information for receiving data of the multicast, wherein the downlink control information includes a repeat request configuration for the repeat request process.

The repeat request process may be a hybrid automatic repeat request (HARQ) process.

The UE may use the repeat request process for reception of data of the multicast, but may not request retransmission, when the UE is in the RRC inactive state.

The UE may use a single repeat request process to receive data of the multicast when the UE is in the RRC connected state and when the UE is in the RRC inactive state.

When the UE is in the RRC inactive state, the UE may attempt to decode each unit of data received using the repeat request process, irrespective of whether that unit of data is retransmitted data or newly transmitted data; and the may UE may determine whether that unit of data is retransmitted data or newly transmitted data after the unit of data has been decoded at the UE.

The method may further comprise: receiving, from the access network node, for a plurality of repeat request processes, scheduling information for requesting retransmission of data of the multicast when the UE is in a radio resource control (RRC) connected state; wherein receiving data of the multicast from the access network node when the UE is in the RRC connected state comprises receiving the data of the multicast using the plurality of repeat request processes; and wherein the UE uses the same plurality of repeat request process used to receive the data of the multicast in the RRC connected state to receive data of the multicast when the UE has transitioned into the RRC inactive state from the RRC connected state.

The scheduling information may include at least one of an indication of an identity of a repeat request process of the plurality of repeat request processes, and an indication of whether data transmitted to the UE using a repeat request process of the plurality of repeat request processes is newly transmitted data or retransmitted data.

The method may further comprise decoding retransmitted data of the multicast, received from the access network node using one the plurality of repeat request processes when in the RRC inactive state, if the same data has not already been decoded at the UE.

The method may further comprise not decoding retransmitted data of the multicast, received using one the plurality of repeat request processes when in the RRC inactive state, if the UE determines that the data of the multicast has already been decoded at the UE.

In a second aspect the disclosure provides a method of a user equipment (UE), the method comprising: receiving first data of a multicast, from an access network node, using a first repeat request process when the UE is in a radio resource control (RRC) connected state; transitioning into an RRC inactive state; and receiving second data of the multicast from the access network node, using a second repeat request process when the UE is in a radio resource control (RRC) connected state; wherein the method comprises at least one of: receiving the first data of the multicast using the first repeat request process and a first set of at least one time resource, and the second repeat request process and a second set of at least one time resource when the UE is in the RRC connected state; and receiving the second data of the multicast using both the first repeat request process and the first set of at least one time resource, and the second repeat request process and the second set of at least one time resource when the UE is in the RRC inactive state; wherein the first set of at least one time resource is configured by the access network node to at least partially overlap with the second set of at least one time resource.

In a third aspect the disclosure provides a method of a user equipment (UE), the method comprising: receiving data of a multicast, from an access network node, using a plurality of first repeat request processes when the UE is in a radio resource control (RRC) connected state; receiving, from the access network node, an RRC release message that indicates that the UE is to transition into an RRC inactive state, wherein the RRC release message includes multicast configuration information for a second repeat request process; releasing, based on the multicast configuration information, the plurality of first repeat request processes; and receiving data of the multicast from the access network node using the second repeat request process when the UE is in the RRC inactive state.

The method may further comprise: receiving first downlink control information for reception of data of the multicast using the plurality of first repeat request processes; and receiving second downlink control information for reception of data of the multicast using the second repeat request process; wherein a format or type of the first downlink control information is different from a format or type of the second downlink control information.

The UE may determine to release the plurality of first repeat request processes based on at least one of: a difference between the format or type of the first downlink control information and the format or type of the second downlink control information; and an indication in the multicast configuration information that a single repeat request process is to be used to receive data of the multicast when the UE is in the RRC inactive state.

In a fourth aspect the disclosure provides a method of a user equipment (UE), the method comprising: receiving data of a multicast from an access network node using a plurality of first repeat request processes when the UE is in a radio resource control (RRC) connected state; receiving, from the access network node, when the UE is in the RRC connected state, multicast configuration information for a second repeat request process for receiving data of the multicast when the UE is in the RRC inactive state; receiving data of the multicast from the access network node, when the UE is in the RRC connected state, using the plurality of first repeat request processes and using the second repeat request process; receiving, from the access network node, an RRC release message that indicates that the UE is to transition into an RRC inactive state; transitioning into the RRC inactive state; and receiving data of the multicast from the access network node using the second repeat request process when the UE is in the RRC inactive state.

The method may further comprise: receiving first downlink control information for reception of data of the multicast using the plurality of first repeat request processes; and receiving second downlink control information for reception of data of the multicast using the second repeat request process; wherein a format or type of the first downlink control information is different from a format or type of the second downlink control information.

In a fifth aspect the disclosure provides a method of a user equipment (UE), the method comprising: receiving data of a multicast from an access network node using at least one multicast radio bearer (MRB), when the UE is in a radio resource control (RRC) connected state; transitioning into an RRC inactive state; receiving data of the multicast from the access network node using the MRB when the UE is in the RRC inactive state; wherein a radio link control (RLC) entity at the UE that is associated with the MRB when the UE is in the RRC connected state is maintained at the UE as the UE transitions into the RRC inactive state.

At least one of a count value or timer for the MRB stored at the UE when the UE is in the RRC connected state may be maintained at the UE as the UE transitions into the RRC inactive state.

The method may comprise switching, before the UE transitions into the RRC inactive state, the RLC entity from a first mode for transmission of repeat request feedback to the access network node, to a second mode in which repeat request feedback is not transmitted to the access network node.

In a sixth aspect the disclosure provides a method of a user equipment (UE), the method comprising: receiving data of a multicast from an access network node using at least one multicast radio bearer (MRB), when the UE is in a radio resource control (RRC) inactive state, wherein the UE uses a repeat request process to receive data of the multicast; transitioning into an RRC connected state; and receiving data of the multicast from the access network node using the MRB, when the UE is in the RRC connected state, and using the MRB and the repeat request process used to receive data of the multicast when the UE was in the RRC inactive state.

Data of the multicast stored in a buffer associated with the repeat request process when the UE is in the RRC inactive state may be maintained in the buffer as the UE transitions into the RRC connected state.

A radio link control (RLC) entity at the UE that is associated with the MRB when the UE is in the RRC inactive state remains may be maintained at the UE as the UE transitions into the RRC inactive state.

In a seventh aspect the disclosure provides a method of a user equipment (UE), the method comprising: receiving data of a multicast from an access network node using at least one multicast radio bearer (MRB), when the UE is in a radio resource control (RRC) inactive state, wherein the UE uses a first repeat request process to receive data of the multicast; transitioning into an RRC connected state; and receiving data of the multicast from the access network node using the MRB, when the UE is in the RRC connected state, using the MRB used to receive the multicast when the UE was in the RRC inactive state, and using a plurality of second repeat request processes, different from the first repeat request process.

A radio link control (RLC) entity at the UE that is associated with the MRB when the UE is in the RRC inactive state remains may be maintained at the UE as the UE transitions into the RRC inactive state.

In an eighth aspect the disclosure provides a method of an access network node, the method comprising: transmitting data of a multicast to a user equipment (UE) using a repeat request process, when the UE is in a radio resource control (RRC) connected state; and transmitting data of the multicast to the UE, using the same repeat request process, when the UE is in a radio resource control (RRC) inactive state.

In an ninth aspect the disclosure provides a method of an access network node, the method comprising: transmitting data of a multicast to a first user equipment (UE) using a first repeat request process and using a first set of at least one time resource, when the first UE is in a radio resource control (RRC) connected state; and transmitting the data of the multicast to a second UE, using a second repeat request process and using a second set of at least one time resource, when the second UE is in an RRC inactive state; wherein the first set of at least one time resource is configured by the access network node to at least partially overlap in time with the second set of at least one time resource.

The first set of at least one time resource may be the same as the second set of at least one time resource.

The method may further comprise: receiving, from the first UE, a request for retransmission of data of the multicast using the first repeat request process; and retransmitting the data of the multicast using the first repeat request process and using a third set of at least one time resource, and not transmitting the retransmission of the multicast data using the second repeat request process and the third set of at least one time resource.

In a tenth aspect the disclosure provides a method of an access network node, the method comprising: transmitting data of a multicast, to a user equipment (UE) using a plurality of first repeat request processes when the UE is in a radio resource control (RRC) connected state; transmitting, to the UE, an RRC release message that indicates that the UE is to transition into an RRC inactive state, wherein the RRC release message includes multicast configuration information for a second repeat request process, wherein the multicast configuration information indicates that the UE is to release the plurality of first repeat request processes; and transmitting data of the multicast to the UE using the second repeat request process when the UE is in the RRC inactive state.

In an eleventh aspect the disclosure provides a method of an access network node, the method comprising: transmitting data of a multicast to a user equipment (UE) using a plurality of first repeat request processes when the UE is in a radio resource control (RRC) connected state; transmitting, to the UE, when the UE is in the RRC connected state, multicast configuration information for a second repeat request process for receiving data of the multicast when the UE is in the RRC inactive state; transmitting data of the multicast to the UE, when the UE is in the RRC connected state, using the plurality of first repeat request processes and using the second repeat request process; transmitting, to the UE, an RRC release message that indicates that the UE is to transition into an RRC inactive state; and transmitting data of the multicast to the UE using the second repeat request process when the UE is in the RRC inactive state.

In a twelfth aspect the disclosure provides a user equipment (UE) comprising: means for receiving data of a multicast, from an access network node, using a repeat request process when the UE is in a radio resource control (RRC) connected state; and means for transitioning into an RRC inactive state; wherein the means for receiving is configured for receiving data of the multicast, from the access network node, when the UE is in the RRC inactive state; and wherein the UE is configured to use the same repeat request process used to receive data of the multicast in the RRC connected state to receive data of the multicast when the UE is in the RRC inactive state.

In a thirteenth aspect the disclosure provides a user equipment (UE) comprising: means for receiving first data of a multicast, from an access network node, using a first repeat request process when the UE is in a radio resource control (RRC) connected state; and means for transitioning into an RRC inactive state; wherein the means for receiving is configured for receiving second data of the multicast from the access network node, using a second repeat request process when the UE is in a radio resource control (RRC) connected state; and wherein the means for receiving is configured for at least one of: receiving the first data of the multicast using the first repeat request process and a first set of at least one time resource, and the second repeat request process and a second set of at least one time resource when the UE is in the RRC connected state; and receiving the second data of the multicast using both the first repeat request process and the first set of at least one time resource, and the second repeat request process and the second set of at least one time resource when the UE is in the RRC inactive state; wherein the first set of at least one time resource is configured by the access network node to at least partially overlap with the second set of at least one time resource.

In a fourteenth aspect the disclosure provides a user equipment (UE) comprising: means for receiving data of a multicast, from an access network node, using a plurality of first repeat request processes when the UE is in a radio resource control, RRC, connected state, and for receiving, from the access network node, an RRC release message that indicates that the UE is to transition into an RRC inactive state, wherein the RRC release message includes multicast configuration information for a second repeat request process; and means for releasing, based on the multicast configuration information, the plurality of first repeat request processes; wherein the means for receiving is configured for data of the multicast from the access network node using the second repeat request process when the UE is in the RRC inactive state.

In a fifteenth aspect the disclosure provides a user equipment (UE) comprising: means for receiving configured for receiving data of a multicast from an access network node using a plurality of first repeat request processes when the UE is in a radio resource control (RRC) connected state; receiving, from the access network node, when the UE is in the RRC connected state, multicast configuration information for a second repeat request process for receiving data of the multicast when the UE is in the RRC inactive state; receiving data of the multicast from the access network node, when the UE is in the RRC connected state, using the plurality of first repeat request processes and using the second repeat request process; and receiving, from the access network node, an RRC release message that indicates that the UE is to transition into an RRC inactive state; and means for transitioning into the RRC inactive state; wherein the means for receiving is further configured for receiving data of the multicast from the access network node using the second repeat request process when the UE is in the RRC inactive state.

In a sixteenth aspect the disclosure provides a user equipment (UE) comprising: means for receiving data of a multicast from an access network node using at least one multicast radio bearer (MRB) when the UE is in a radio resource control (RRC) connected state; and means for transitioning into an RRC inactive state; wherein the means for receiving is configured for receiving data of the multicast from the access network node using the MRB when the UE is in the RRC inactive state; and wherein the UE is configured to maintain a radio link control (RLC) entity at the UE that is associated with the MRB when the UE is in the RRC connected state, as the UE transitions into the RRC inactive state.

In a seventeenth aspect the disclosure provides a user equipment (UE) comprising: means for receiving data of a multicast from an access network node using at least one multicast radio bearer (MRB) when the UE is in a radio resource control (RRC) inactive state, wherein the UE is configured to use a repeat request process to receive data of the multicast; and means for transitioning into an RRC connected state; wherein the means for receiving is configured for receiving data of the multicast from the access network node using the MRB, when the UE is in the RRC connected state, and using the MRB and the repeat request process used to receive data of the multicast when the UE was in the RRC inactive state.

In an eighteenth aspect the disclosure provides a user equipment (UE) comprising: means for receiving data of a multicast from an access network node using at least one multicast radio bearer (MRB) when the UE is in a radio resource control (RRC) inactive state, wherein the UE is configured to use a first repeat request process to receive data of the multicast; and means for transitioning into an RRC connected state; wherein the means for receiving is configured for receiving data of the multicast from the access network node using the MRB, when the UE is in the RRC connected state, using the MRB used to receive the multicast when the UE was in the RRC inactive state, and using a plurality of second repeat request processes, different from the first repeat request process.

In a nineteenth aspect the disclosure provides an access network node comprising: means for transmitting data of a multicast to a user equipment (UE) using a repeat request process, when the UE is in a radio resource control (RRC) connected state; wherein the means for transmitting is configured for transmitting data of the multicast to the UE, using the same repeat request process, when the UE is in a radio resource control (RRC) inactive state.

The method may further comprise transmitting, to the UE, downlink control information for receiving data of the multicast, wherein the downlink control information includes a repeat request configuration for the repeat request process.

The repeat request process may be a hybrid automatic repeat request (HARQ) process.

The access network node may optionally only use a single repeat request process to transmit data of the multicast to the UE when the UE is in the RRC connected state and when the UE is in the RRC inactive state.

The method may further comprise: transmitting, to the UE, for a plurality of repeat request processes, scheduling information for use by the UE to request retransmission of downlink data of the multicast when the UE is in a radio resource control (RRC) connected state; wherein transmitting data of the multicast to the UE when the UE is in the RRC connected state comprises transmitting data of the multicast using the plurality of repeat request processes; and wherein transmitting data of the multicast to the UE when the UE is in the RRC inactive state comprises transmitting data of the multicast to the UE using the same plurality of repeat request processes.

In a twentieth aspect the disclosure provides an access network node comprising: means for transmitting data of a multicast to a first user equipment (UE) using a first repeat request process and using a first set of at least one time resource, when the first UE is in a radio resource control (RRC) connected state; wherein the means for transmitting is configured for transmitting the data of the multicast to a second UE, using a second repeat request process and using a second set of at least one time resource, when the second UE is in an RRC inactive state; and wherein the access network node further comprises means for configuring the first set of at least one time resource to at least partially overlap in time with the second set of at least one time resource.

In a twenty-first aspect the disclosure provides an access network node comprising: means for transmitting configured for: transmitting data of a multicast, to a user equipment (UE) using a plurality of first repeat request processes when the UE is in a radio resource control (RRC) connected state; transmitting, to the UE, an RRC release message that indicates that the UE is to transition into an RRC inactive state, wherein the RRC release message includes multicast configuration information for a second repeat request process, wherein the multicast configuration information indicates that the UE is to release the plurality of first repeat request processes; and transmitting data of the multicast to the UE using the second repeat request process when the UE is in the RRC inactive state.

In a twenty-second aspect the disclosure provides an access network node comprising: means for transmitting configured for: transmitting data of a multicast to a user equipment (UE) using a plurality of first repeat request processes when the UE is in a radio resource control (RRC) connected state; transmitting, to the UE, when the UE is in the RRC connected state, multicast configuration information for a second repeat request process for receiving data of the multicast when the UE is in the RRC inactive state; transmitting data of the multicast to the UE, when the UE is in the RRC connected state, using the plurality of first repeat request processes and using the second repeat request process; transmitting, to the UE, an RRC release message that indicates that the UE is to transition into an RRC inactive state; and transmitting data of the multicast to the UE using the second repeat request process when the UE is in the RRC inactive state.

### BRIEF DESCRIPTION OF DRAWINGS

Example embodiments of the disclosure will now be described, by way of example, with reference to the accompanying drawings in which:

FIG. 1 schematically illustrates a mobile (‘cellular’ or ‘wireless’) communication system;

FIG. 2 illustrates a typical frame structure that may be used in the communication system of FIG. 1;

FIG. 3 illustrates an illustration of point-to-point (PTP) and point-to-multipoint (PTM) communications;

FIG. 4 illustrates a flow diagram illustrating a method in which a UE continues to receive a multicast transmission in an RRC inactive state;

FIG. 5 shows an example of information for maintaining a PTM leg at a UE;

FIG. 6 shows a flow diagram illustrating a method in which a UE continues to receive a multicast transmission in an RRC connected state;

FIG. 7 illustrates a method in which an MBS radio bearer (MRB) list is transmitted to the UE;

FIG. 8 shows a first example of an RLC configuration;

FIG. 9 shows a second example of an RLC configuration;

FIG. 10 illustrates a method in which a UE enters an RRC connected state and receives an MRB configuration;

FIG. 11 illustrates a further method in which the UE enters the RRC connected state;

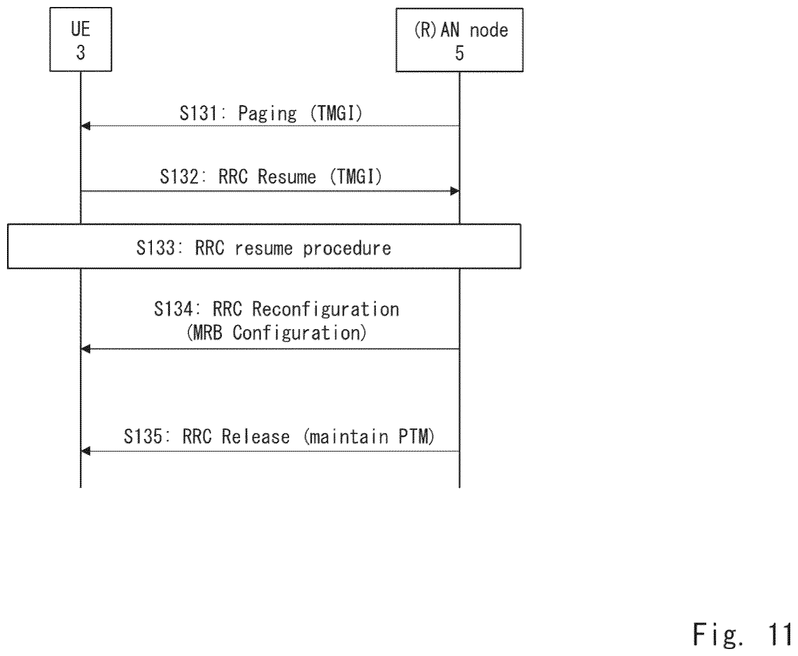

FIG. 12 illustrates a first part of a method of establishing and joining a multicast session;

FIG. 13 illustrates a second part of the method of establishing and joining the multicast session;

FIG. 14 illustrates a third part of the method of establishing and joining the multicast session;

FIG. 15 illustrates a first part of a method of MBS session activation and deactivation;

FIG. 16 illustrates a second part of the method of MBS session activation and deactivation;

FIG. 17 illustrates a method in which a UE does not enter the RRC connected state if a PTM configuration is available at the UE;

FIG. 18 shows a flow diagram illustrating a method in which a UE receive downlink control information (DCI) from a base station;

FIG. 19 shows an example of HARQ processes for RRC inactive and RRC connected UEs;

FIG. 20 shows a flow diagram illustrating a method in which a UE receives a multicast transmission after a transition to an RRC inactive state;

FIG. 21 shows an example of HARQ processes for a UE that transitions from an RRC connected state to an RRC inactive state;

FIG. 22 shows a flow diagram illustrating a method in which a UE receives a configuration for a multicast radio bearer (MRB) before a transition to an RRC inactive state;

FIG. 23 shows a further example of HARQ processes for a UE that transitions from an RRC connected state to an RRC inactive state;

FIG. 24 is a schematic block diagram illustrating the main components of a UE 3; and

FIG. 25 illustrates a schematic block diagram illustrating the main components of a base station.

### DESCRIPTION OF EMBODIMENTS

### Overview

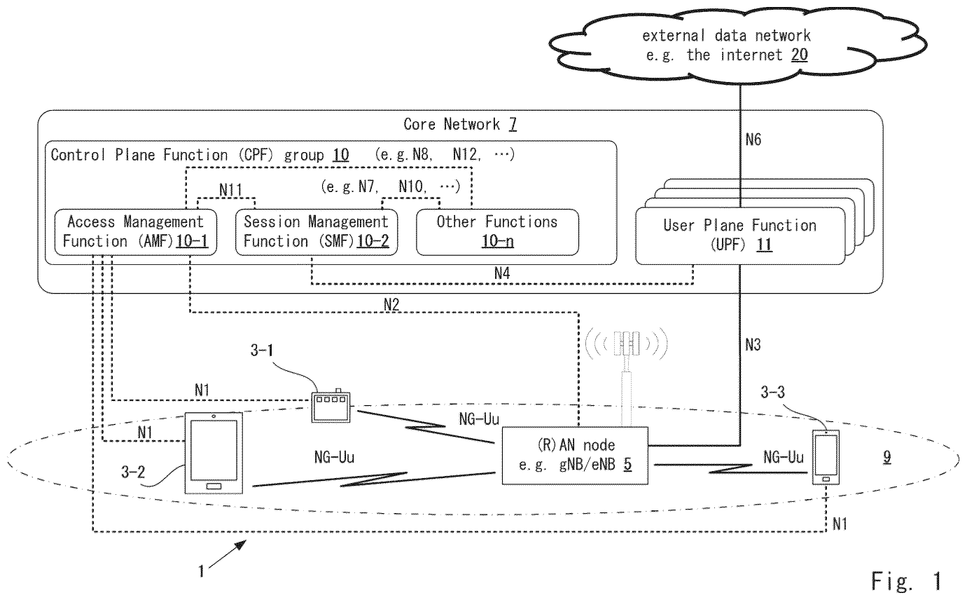

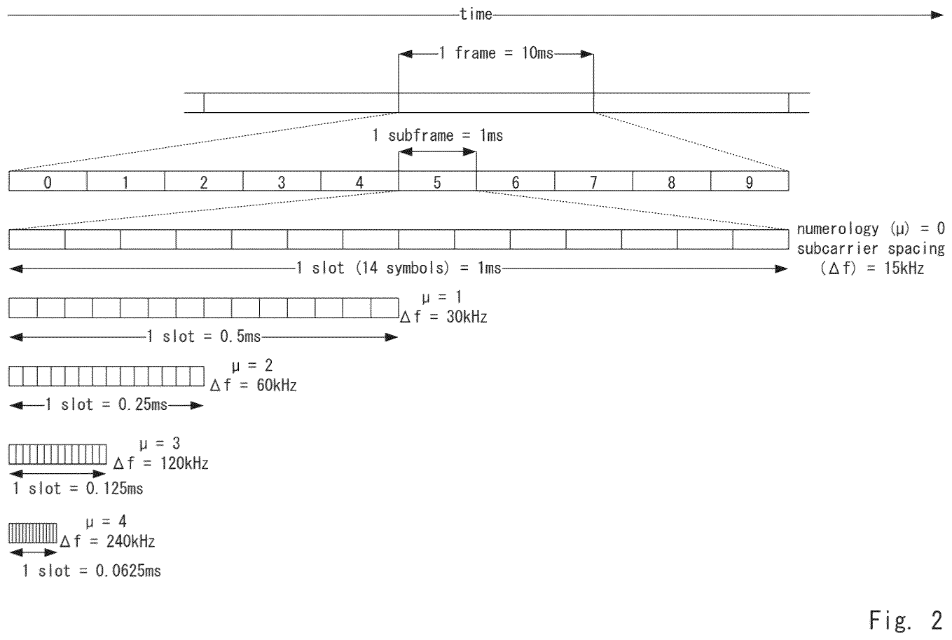

An exemplary communication system will now be described in general terms, by way of example only, with reference to FIGS. 1 and 2.

FIG. 1 schematically illustrates a mobile (‘cellular’ or ‘wireless’) communication system 1 to which example embodiments of the present disclosure are applicable.

In the communication system 1, user equipment (UEs) 3-1, 3-2, 3-3 (e.g. mobile telephones and/or other mobile devices) can communicate with each other via a radio access network (RAN) node 5 that operates according to one or more compatible radio access technologies (RATs). In the illustrated example, the RAN node 5 comprises a NR/5G base station or ‘gNB’ 5 operating one or more associated cells 9. Communication via the base station 5 is typically routed through a core network 7 (e.g. a 5G core network or evolved packet core network (EPC)).

As those skilled in the art will appreciate, whilst three UEs 3 and one base station 5 are shown in FIG. 1 for illustration purposes, the system, when implemented, will typically include other base stations 5 and UEs 3.

Each base station 5 controls one or more associated cells 9 either directly, or indirectly via one or more other nodes (such as home base stations, relays, remote radio heads, distributed units, and/or the like). It will be appreciated that the base stations 5 may be configured to support 4G, 5G, 6G, and/or any other 3GPP or non-3GPP communication protocols.

The UEs 3 and their serving base station 5 are connected via an appropriate air interface (for example the so-called ‘Uu’ interface and/or the like). Neighbouring base stations 5 may be connected to each other via an appropriate base station to base station interface (such as the so-called ‘X2’ interface, ‘Xn’ interface and/or the like).

The core network 7 includes a number of logical nodes (or ‘functions’) for supporting communication in the communication system 1. In this example, the core network 7 comprises control plane functions (CPFs) 10 and one or more user plane functions (UPFs) 11. The CPFs 10 include one or more Access and Mobility Management Functions (AMFs) 10-1, one or more Session Management Functions (SMFs) 10-2 and a number of other functions 10-n.

The base station 5 is connected to the core network nodes via appropriate interfaces (or ‘reference points’) such as an N2 reference point between the base station 5 and the AMF 10-1 for the communication of control signalling, and an N3 reference point between the base station 5 and each UPF 11 for the communication of user data. The UEs 3 are each connected to the AMF 10-1 via a logical non-access stratum (NAS) connection over an N1 reference point (analogous to the S1 reference point in LTE). It will be appreciated, that N1 communications are routed transparently via the base station 5.

One or more UPFs 11 are connected to an external data network (e.g. an IP network such as the internet) via reference point N6 for communication of the user data.

The AMF 10-1 performs mobility management related functions, maintains the NAS signalling connection with each UE 3 and manages UE registration. The AMF 10-1 is also responsible for managing paging. The SMF 10-2 provides session management functionality (that formed part of MME functionality in LTE) and additionally combines some control plane functions (provided by the serving gateway and packet data network gateway in LTE). The SMF 10-2 also allocates IP addresses to each UE 3.

The base station 5 (which may also be referred to as an access network node 5) of the communication system 1 is configured to operate at least one cell 9 on an associated TDD carrier that operates in unpaired spectrum. It will be appreciated that the base station 5 may also operate at least one cell 9 on an associated FDD carrier that operates in paired spectrum.

The base station 5 is also configured for transmission of, and the UEs 3 are configured for the reception of, control information and user data via a number of downlink (DL) physical channels and for transmission of a number of physical signals. The DL physical channels correspond to resource elements (REs) carrying information originated from a higher layer, and the DL physical signals are used in the physical layer and correspond to REs which do not carry information originated from a higher layer.

The physical channels may include, for example, a physical downlink shared channel (PDSCH), a physical broadcast channel (PBCH), and a physical downlink control channel (PDCCH). The PDSCH carries data sharing the PDSCH's capacity on a time and frequency basis. The PDSCH can carry a variety of items of data including, for example, user data, UE-specific higher layer control messages mapped down from higher channels, system information blocks (SIBs), and paging. The PDCCH carries downlink control information (DCI) for supporting a number of functions including, for example, scheduling the downlink transmissions on the PDSCH and also the uplink data transmissions on a physical uplink shared channel (PUSCH). The PBCH provides UEs 3 with the Master Information Block (MIB). It also, in conjunction with the PDCCH, supports the synchronisation of time and frequency, which aids cell acquisition, selection and re-selection. The UE 3 may receive a Synchronization Signal Block (SSB), and the UE 3 may assume that reception occasions of a PBCH, primary synchronization signal (PSS) and secondary synchronization signal (SSS) are in consecutive symbols and form a SS/PBCH block. The base station 5 may transmit a number of synchronization signal (SS) blocks corresponding to different DL beams. The total number of SS blocks may be confined, for example, within a 5 ms duration as an SS burst. The periodicity of the SSB transmissions may be indicated to the UE using any suitable signalling (e.g. per serving cell using ssb-periodicityServingCell). The periodicity value for the SSB may be, for example, greater than or equal to 20 ms. For initial cell selection, the UE 3 may be configured to assume that an SS burst occurs with a periodicity of 2 frames. The UE 3 may also be provided with an indication of which SSBs within a 5 ms duration are transmitted (e.g. using ssb-PositionsInBurst).

The DL physical signals may include, for example, reference signals (RSs) and synchronization signals (SSs). A reference signal (sometimes known as a pilot signal) is a signal with a predefined special waveform known to both the UE 3 and the base station 5. The reference signals may include, for example, cell specific reference signal, UE-specific reference signal (UE-RS), downlink demodulation signal (DMRS), and channel state information reference signal (CSI-RS).

Similarly, the UEs 3 are configured for transmission of, and the base station 5 is configured for the reception of, control information and user data via a number of uplink (UL) physical channels corresponding to REs carrying information originated from a higher layer, and UL physical signals which are used in the physical layer and correspond to REs which do not carry information originated from a higher layer. The physical channels may include, for example, the PUSCH, a physical uplink control channel (PUCCH), and/or a physical random-access channel (PRACH). The UL physical signals may include, for example, demodulation reference signals (DMRS) for a UL control/data signal, and/or sounding reference signals (SRS) used for UL channel measurement.

When the UE 3 initially establishes an RRC connection with a base station 5 via a cell it registers with an appropriate AMF 9 (or MME). The UE 3 is in the so-called RRC connected state and an associated UE context is maintained by the network. The UE 3 may transition from the RRC connected state to an RRC idle state, or to an RRC inactive state. For example, the UE 3 may transition from the RRC connected state to the RRC inactive state in response to receiving, from the base station 5, an RRC release message including an indication that the UE 3 is to enter (transition into) the RRC inactive state (e.g. suspendConfig). The UE 3 may transition from the RRC inactive state to the RRC connected state, and may transmit a corresponding RRC Resume request to the base station 5. The UE 3 may transition from the RRC inactive state to the RRC connected state in response to receiving paging from the base station 5 (e.g. group paging for a group of UEs 3). When the UE 3 is in the so-called RRC idle state, or in the RRC inactive state, it selects an appropriate cell for camping so that the network is aware of the approximate location of the UE 3 (although not necessarily on a cell level). It will be appreciated that the RRC inactive state may be considered to be an intermediate state in between the RRC connected state and the RRC idle state, in which RRC is not completely released so that the UE 3 is able to more rapidly return to the RRC connected state for transmission and/or reception of transmissions to or from the base station 5.

### Frame Structure

Referring to FIG. 2, which illustrates the typical frame structure (time resources) that may be used in the communication system 1, the base station 5 and UEs 3 of the communication system 1 communicate with one another using resources that are organised, in the time domain, into frames of length 10 ms. Each frame comprises ten equally sized subframes of 1 ms length. Each subframe is divided into one or more slots comprising 14 Orthogonal frequency-division multiplexing (OFDM) symbols of equal length.

As seen in FIG. 2, the communication system 1 supports multiple different numerologies (subcarrier spacing (SCS), slot lengths and hence OFDM symbol lengths). Specifically, each numerology is identified by a parameter, μ, where μ=0 represents 15 kHz (corresponding to the LTE SCS). Currently, the SCS for other values of μ can, in effect, be derived from μ=0 by scaling up in powers of 2 (i.e. SCS=15×2 μ kHz). The relationship between the parameter, μ, and SCS (Δf) is as shown in Table 1:

TABLE 1
5G Numerology

| | | Number of slots | Slot length |
|---|---|---|---|
| μ | Δf = 2^{μ} · 15[kHz] | per subframe | (ms) |
| 0 | 15 | 1 | 1 |
| 1 | 30 | 2 | 0.5 |
| 2 | 60 | 4 | 0.25 |
| 3 | 120 | 8 | 0.125 |
| 4 | 240 | 16 | 0.0625 |

### System Information and SIB

It will be appreciated that transmissions in a cell 9 of a base station 5 may include one or more broadcast transmissions, one or more unicast transmissions for reception by a UE 3, or one or more multicast transmissions for reception by a corresponding group of UEs 3. System information (SI) transmitted in a cell may include ‘minimum SI’ (MSI) and ‘other SI’ (OSI). The OSI may be broadcast on-demand, for example using a downlink shared channel (DL-SCH). The OSI may be broadcast upon request from a UE 3 that is in a radio resource control (RRC) idle or RRC inactive state. The OSI may also be requested by a UE 3 that is in the RRC connected state, for example via one or more dedicated RRC transmissions.

The SI may include information for enabling (e.g. configuring) the UE 3 to complete a cell selection, may include information for enabling the UE 3 to complete a cell reselection procedure, or for enabling the UE 3 to receive one or more paging messages transmitted in a cell. SI may be broadcast using a Master Information Block (MIB) and one or more System Information Blocks (SIB).

The MSI comprises the MIB and system information block 1 (SIB1). The MIB includes information for use by a UE 3 to receive SIB1, for example a subcarrier spacing for SIB1. The MIB provides information corresponding to a Control Resource Set (CORESET) and Search Space. SIB1 may be referred to as ‘remaining MSI’ (RMSI). SIB1 may be transmitted in a dedicated RRC message, and other SIB (e.g. SIB2 to SIB9) may be transmitting using one or more other suitable RRC transmissions. The MIB and SIB1 may provide the UE 3 with an indication of scheduling information for receiving and decoding the other SIB, such as SIB2 to SIB9, and may provide information for use by the UE 3 to receive one or more paging messages. The OSI may comprise, for example, SIB2 to SIB9 transmitted using a DL-SCH in SI messages. A mapping of SIB2 to SIB9 to corresponding SI messages may be provided to the UE 3 by the base station 5. MIB and SIB1 to SIB9 are described in more detail, for example, in 3GPP TS 38.331. For example, SIB2 provides information for intra-frequency, inter-frequency and inter-system cell reselection, SIB3 provides cell-specific information for intra-frequency cell reselection, and SIB4 provides information for inter-frequency cell reselection. SIB5 provides information regarding inter-system cell reselection towards 4G (LTE). SIB6 and SIB7 provide information for an earthquake and tsunami warning system (ETWS). SIB8 provides information for a commercial mobile alert service (CMAS) notification, for example to provide warning text messages to the UE 3. SIB9 includes information regarding coordinated universal time (UTC), global positioning system (GPS) time (e.g. for GPS initialisation) and local time.

SIB may be broadcast periodically (e.g. according to a predetermined periodic pattern), or alternatively may be provided ‘on-demand’, for example in response to a request from a UE 3. For example, MIB may be transmitted with a periodicity of 80 ms and repetitions made within 80 ms, and SIBI may be transmitted with a periodicity of 160 ms and a variable transmission repetition periodicity within 160 ms (e.g. 20 ms). SIB1 can be used to indicate to a UE 3 which SIB are transmitted periodically and which SIB are available on-demand in response to a request from the UE 3. A UE 3 may be configured to request on-demand SIB using MSG1 (random access preamble (RA)), which may be referred to as a MSG1-based on-demand SI request, or MSG3 (RRC Connection Request), which may be referred to as a MSG3-based on-demand SI request.

A physical broadcast channel (PBCH) can be used to broadcast the MIB. The base station 5 may transmit the PBCH with synchronisation signals (SS) (e.g. primary synchronisation signal (PSS) and secondary synchronisation signal (SSS)) in a SS/PBCH Block. The SS/PBCH block comprises four orthogonal frequency-division multiplexed (OFDM) symbols that are mapped to PSS, SSS and PBCH associated with a demodulation reference signal (DM-RS). In the frequency domain, an SS/PBCH block consists of 240 contiguous subcarriers. When the UE 3 is in an RRC connected mode, the base station 5 may provide the UE 3 with an indication of resources used for the SS/PBCH, for example using dedicated signalling (e.g. for an anchor NES cell or a non-anchor NES cell). SIB1 may be transmitted using a physical downlink shared channel (PDSCH). The OSI may be similarly transmitted, for example, using a PDSCH.

When one or more beamformed transmissions are transmitted in a cell provided by the base station 5, some of the SI (e.g. some of the SIB) may only be transmitted using particular beams, or using a particular transmission/reception point (TRP).

### Multicast and Broadcast Services (MBS)

Methods for providing MBS will now be described. Methods for maintaining multicast transmissions (e.g. in which continuity of the MBS service is maintained) between a base station 5 and a UE 3, including point-to-multipoint (PTM) transmissions, will be described.

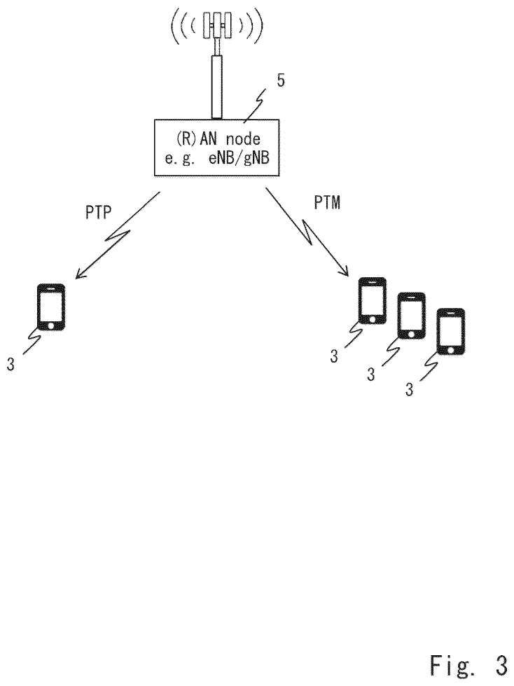

A multicast service may include a PTP leg between a base station 5 and a single UE 3, and a PTM leg between the base station 5 and a plurality of UEs 3. PTP and PTM transmissions are illustrated schematically in FIG. 3. It will be appreciated that whilst the UEs 3 are shown separately in FIG. 3, a UE 3 may receive both the PTP and PTM parts of the multicast. PTP may be described as a PTP ‘leg’ or ‘part’ of a multicast transmission. Similarly, PTM may be described as a PTM ‘leg’ or ‘part’ of a multicast transmission.

The PTM leg has an MBS radio bearer (MRB) in the MBS session, that has a corresponding MRB configuration. Each MRB may have an associated identifier (e.g. MRB-Identity) that can be used to identify the MRB. The MRB identity may be included in any suitable transmission for MRB configuration. A multicast service may be suspended (a process in which MRBs are released) or re-activated based on multicast data activity (or inactivity). The configuration of one or more MRBs may be provided to the UE 3 and/or the base station 5, for example, in any suitable radio link control (RLC) configuration signalling (e.g. in an RLC Bearer Configuration message).

The base station 5 may provide a multicast MRB configuration to the UE 3 via dedicated signalling. The multicast MRB may be DL only RLC unacknowledge mode (RLC-UM), in which acknowledge/negative-acknowledge (ACK/NACK) feedback is not transmitted, or the MRB may have a bidirectional RLC-UM configuration for PTP transmission.

The multicast MRB configuration may include an RLC-acknowledge mode (RLC-AM) configuration for transmission of ACK/NACK feedback. The multicast MRB configuration may include an RLC-unacknowledge mode (RLC-UM) configuration in which ACK/NACK feedback is not transmitted.

The multicast MRB configuration may include an RLC-AM entity for PTP transmission.

The multicast MRB configuration may include a DL only RLC-UM entity for PTM transmission.

The multicast MRB configuration may include two RLC-UM entities. One of the RLC-UM entities may be a DL only RLC-UM entity for PTP transmission, and the other RLC-UM entity may be a DL only RLC-UM entity for PTM transmission.

The multicast MRB configuration may include three RLC-UM entities, wherein one of the RLC-UM entities is a DL only RLC-UM entity, one of the RLC-UM entities is an UL RLC-UM entity for PTP transmissions, and the other RLC-UM entity is a DL only RLC-UM entity for PTM transmission.

The multicast MRB configuration may include two RLC entities, wherein one of the RLC entities is an RLC-AM entity for PTP transmission, and the other RLC entity is a DL only RLC-UM entity for PTM transmission.

Multicast MRBs may be suspended when the UE 3 transitions from an RRC connected state to the RRC inactive state. A PTP leg of the multicast may be unsuitable for use when UE is in RRC inactive state because the PTP leg is UE specific, and the resources required to provide the PTP leg may increase linearly with the number of UEs. However, in the present examples, advantageously the PTM part of the multicast can be maintained (or configured) even when the UE 3 is in the RRC inactive state.

When a UE 3 performs cell reselection to a neighbouring cell in the RRC inactive state (without resuming the RRC connection), it is advantageous to be able maintain reception of multicast transmissions. Methods of configuring, resuming and maintaining a multicast when a UE is in the RRC inactive state will be described later.

Improved procedures for maintaining a PTM leg of a multicast when a UE 3 transitions from an RRC connected state to an RRC inactive state will now be described. It will be appreciated that the in the methods described below the PTM transmissions from the base station may be received by received by UEs that are in the RRC inactive state as well as UEs that are in the RRC connected state.

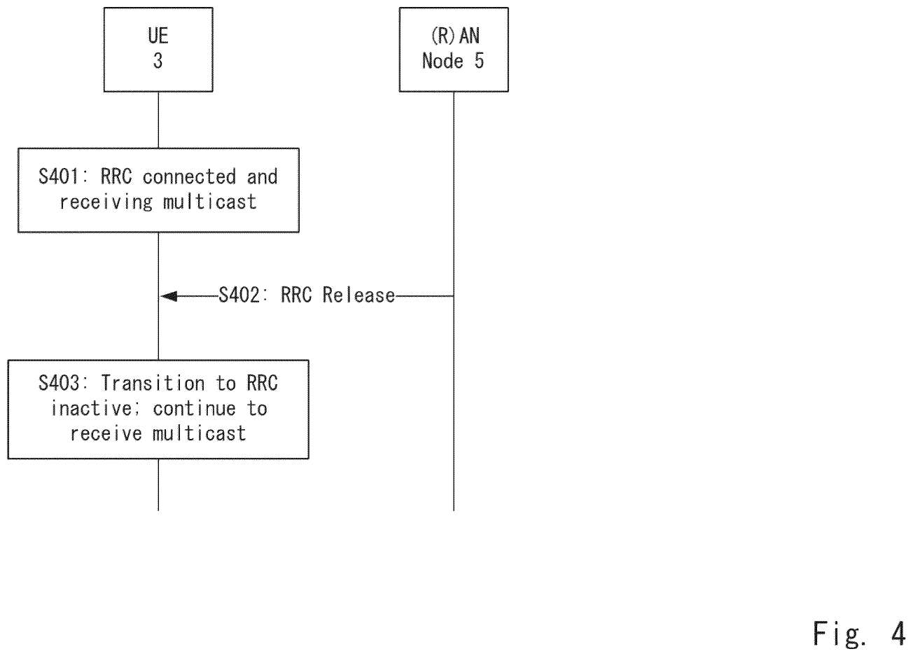

Maintaining PTM for a Multicast FIG. 4 shows an example in which a UE 3 transitions from an RRC connected state to an RRC inactive state, but advantageously maintains a PTM leg of a multicast transmission.

In step S401 the UE 3 is in the RRC connected state and receives a multicast transmission from a base station (an access network node) 5. An MRB including a PTM leg has been configured for the UE 3, and a PTM leg may also have been configured for the UE 3.

In step S402, the UE 3 receives an RRC Release message from the base station 5. The base station 5 may determine to transmit the RRC Release message to the UE 3, for example, in order to reduce congestion in a cell of the base station 5, or due to a period of data inactivity for the multicast. The RRC Release message may include an indication that a corresponding configuration is to be suspended (e.g. an information element such as suspendConfig). Advantageously, in the present example, the RRC Release message includes (e.g. in SuspendConfig) information for maintaining at least one PTM leg at the UE 3 (e.g. information indicating that the UE 3 is to store information corresponding to the PTM leg). The information for maintaining at least one PTM leg may also be referred to as a ‘multicast indication’.

In step S403, the UE 3 enters an RRC inactive state in response to receiving the RRC Release message. However, since the UE 3 received, in the RRC release message of step S402, the information for maintaining the PTM leg, the UE 3 is advantageously able to continue to receive the PTM leg of the multicast transmission.

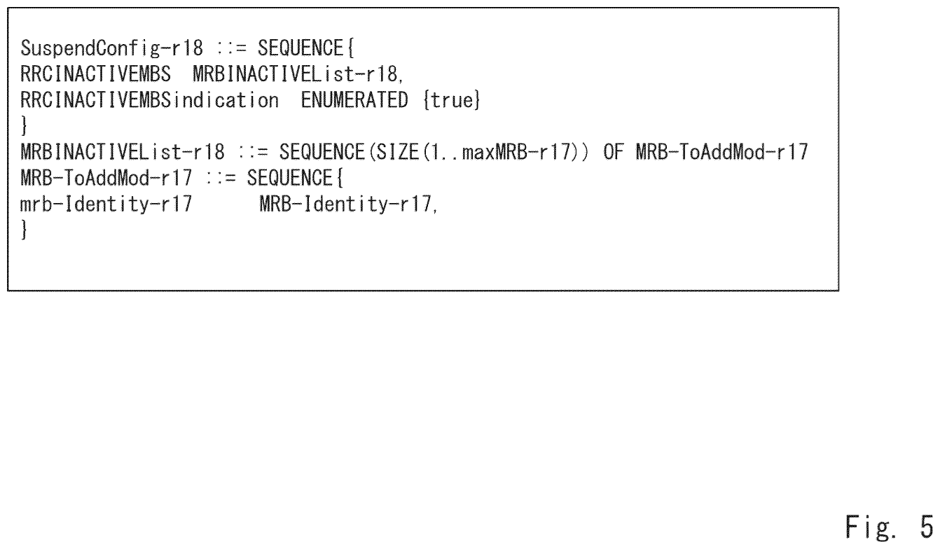

An example of information for maintaining at least one PTM leg at the UE 3, that may be included in the RRC Release message of step S402, is shown in FIG. 5. However, it will be appreciated that the information for maintaining the at least one PTM leg at the UE 3 may have any other suitable format. In this example, the information includes an indication ‘RRCINACTIVEMBS’, that is an indication of whether the UE 3 should keep (maintain) the PTM RLC entity of the MRB of the multicast when the UE 3 is in the RRC inactive state. In other words, upon reception of the indication, the UE 3 determines whether to maintain the PTM RLC entity of the MRB. The indication may be, for example, ‘TRUE’ indicating that the UE 3 is to maintain the PTM RLC entity of the MRB, or ‘FALSE’ indicating that the UE 3 is not to maintain the PTM RLC entity of the MRB (although it will be appreciated that the indication need not necessarily be ‘TRUE’ or ‘FALSE’, and that any other suitable indication such as ‘0’ or ‘1’ could alternatively be used). As shown in FIG. 5, in this example the information included in the RRC release message includes a list of MRB, and the UE 3 may determine to maintain the PTM RLC entity for the MRB indicated in the list.

In a case where the MBS session has finished or deactivated, the indication of whether the UE 3 should maintain at least one PTM leg can be used to indicate that the PTM leg is not to be maintained at the UE 3.

The RRC release message received at the UE 3 from the network (e.g. from the base station 5) may include an indication of a configuration for MBS for a neighbouring cell. The information may include a neighbour cell configuration that is associated with an MBS session list. The neighbour cell MBS session configuration can be used to implicitly indicate which MBS session (MRB) is to be maintained when the UE 3 enters the RRC inactive state. However, an explicit indication such as that illustrated in FIG. 5 may be preferable, in order to avoid any ambiguity for the indication.

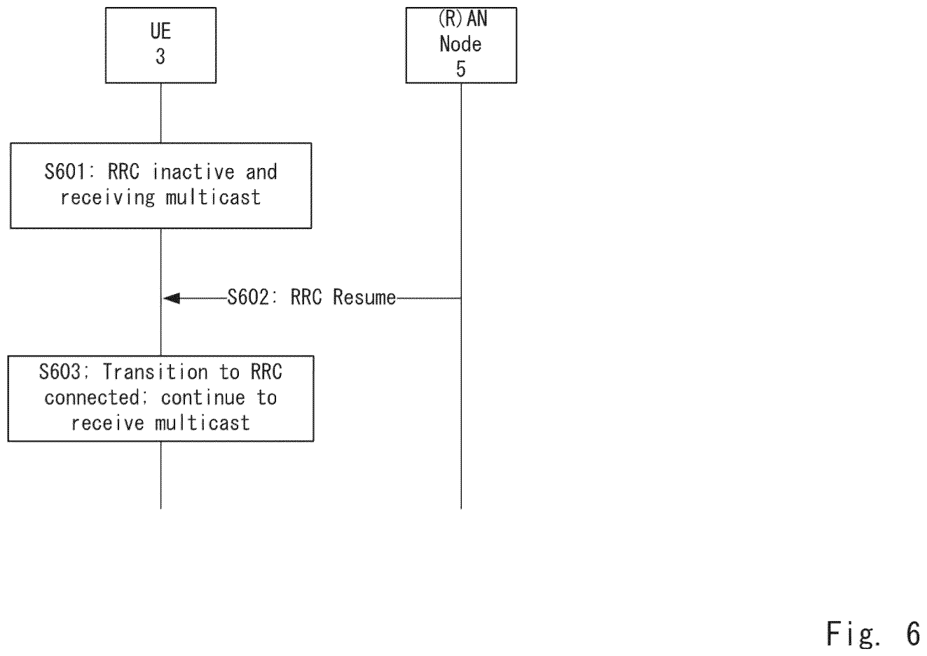

FIG. 6 shows a flow diagram illustrating a method in which a UE continues to receive a multicast transmission in an RRC connected state. In step S601 the UE 3 is in an RRC inactive state and is receiving a multicast transmission that is transmitted by the base station. In step 602 the base station 5 transmits an RRC resume message to the UE 3 (for example, after a determination by the base station 5 that the UE 3 is to transition to an RRC connected state). As described above with reference to the RRC release message of step S402 of FIG. 4, the RRC resume message may similarly include information for maintaining at least one PTM leg at the UE 3. In step S603 the UE 3 transitions to the RRC connected state and continues to receive the multicast transmission.

### DU and CU

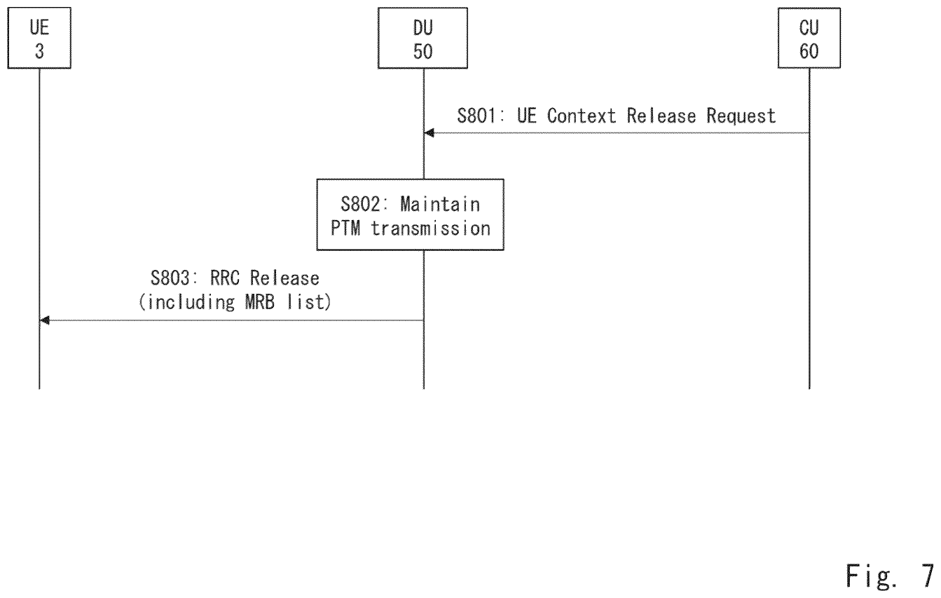

FIG. 7 shows an example in which an MRB list is transmitted to the UE 3 as part of an RRC release procedure involving a DU 50 and a CU 60. The DU 50 may also be referred to as ‘a first unit’ of an access network node 5 for radio communication with a UE 3, and the CU 60 may be referred to as a ‘second unit’ of the access network node 5. At the beginning of the method shown in FIG. 7 the UE 3 is in the RRC connected state and is receiving a multicast transmission from the DU 50, including a PTM transmission.

In step S801, the CU 60 transmits a UE Context Release Request message to the DU 50. The UE Context Release Request includes an identifier of the UE (e.g. ‘UE ID’). In this example, the UE Context Release Request also includes a list of MRB to be maintained for the UE 3 when the UE 3 enters an RRC inactive state. Alternatively, the UE Context Release Request may include an indication that all of the MRB for PTM transmission for the UE 3 are to be maintained (e.g. using an indication such as ‘KeepPTMindication’ which may be, for example: ‘TRUE’ or ‘FALSE’; or similarly, ‘1’ or ‘0’). The indication of which MRB the DU 50 should keep (e.g. continue store a configuration for, or transmit) may be in the form of any suitable information element or list, such as ‘MRB_ID list of INACTIVE’. Upon reception of the indication included in the UE Context Release Request, the DU 50 may determine to keep the UE 3 context, and keep one or more multicast F-U tunnels which are associated with the list of bearers (e.g. ‘MRB_ID list of INACTIVE’) with the CU-UP. Since the indication included in the UE Context Release Request corresponds to a particular UE 3, the indication may be referred to as a ‘UE specific’ indication. Based on the indication, the DU 50 is able to determine which MBS service the UE 3 is to receive when the UE 3 is in the RRC inactive state.

In step S802, the DU 50 determines to maintain the MRB for PTM transmission based on the information included in the UE Context Release Request. The DU 50 may determine, based on an indication in the UE Context Release Request, that the DU 50 is to continue PTM transmissions for the UE 3 (e.g. all of the PTM transmissions from the DU 50, or a set of PTM transmissions indicated in the UE Context Release Request).

In step S803, the DU 50 transmits an RRC release message to the UE 3. The RRC release message includes a set (e.g. a list) of the MRB for the PTM transmissions that are to be maintained at the UE 3. The UE 3 receives the MRB list and determines to maintain (e.g. continue to store a configuration for) the MRB indicated in the list. The set of the MRB may also be referred to as a ‘multicast indication’. The UE 3 may maintain a PTM leg corresponding to the MRB indicated in the MRB list. Advantageously, therefore, the UE 3 is able to continue to receive the multicast transmissions from the DU 50 even after the UE 3 has transitioned to the RRC inactive state.

If the UE 3 is the only UE 3 in the cell that is in the RRC connected state and is to use an MBS session, then when the CU 60 releases the RRC connection of the UE 3 using the UE Context Release Request, advantageously the CU 60 can indicate to the DU 50 using the list of MRB to be maintained for the UE 3 (or the indication that all of the MRB for PTM transmission to the UE 3 are to be maintained) that the DU 50 is to maintain a PTM transmission for the UE 3. Therefore, the UE 3 able to continue to receive the PTM transmission even after there are no more UEs 3 in the cell in the RRC connected state (which may otherwise cause the DU 50 to discontinue the PTM transmissions). Moreover, since the RRC release message received at the UE 3 from the DU 50 includes the list of MRB to be maintained, the UE 3 is able to perform control to receive the corresponding PTM transmissions.

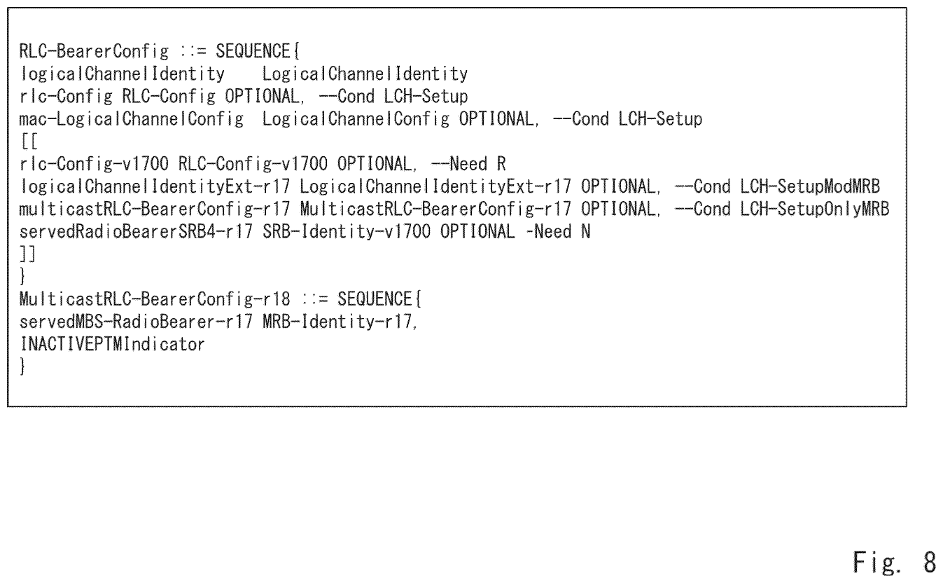

MRB for PTM transmission are configured when the UE 3 is in an RRC connected state. The PTM RLC entities for different UEs 3 may be different, since the PTM RLC entity of each UE 3 is configured individually. An RLC configuration may include, amongst other information, a logical channel identity (e.g. ‘logicalChannelIdentity’) and a multicast RLC bearer configuration. In this example when a UE 3 RRC connection is released to the inactive state and the UE 3 maintains a PTM RLC entity (e.g. based on the MRB list received from the DU 50), the network (e.g. base station 5) maintains the corresponding PTM RLC entity at the network. More generally, since a configuration used for PTM for a particular UE 3 may be different to a configuration used for PTM for another UE 3, when a particular UE 3 is to maintain a configuration for PTM based on the method shown in FIG. 8, the configuration is also maintained at the network (e.g. at the DU 50).

### RLC Configuration

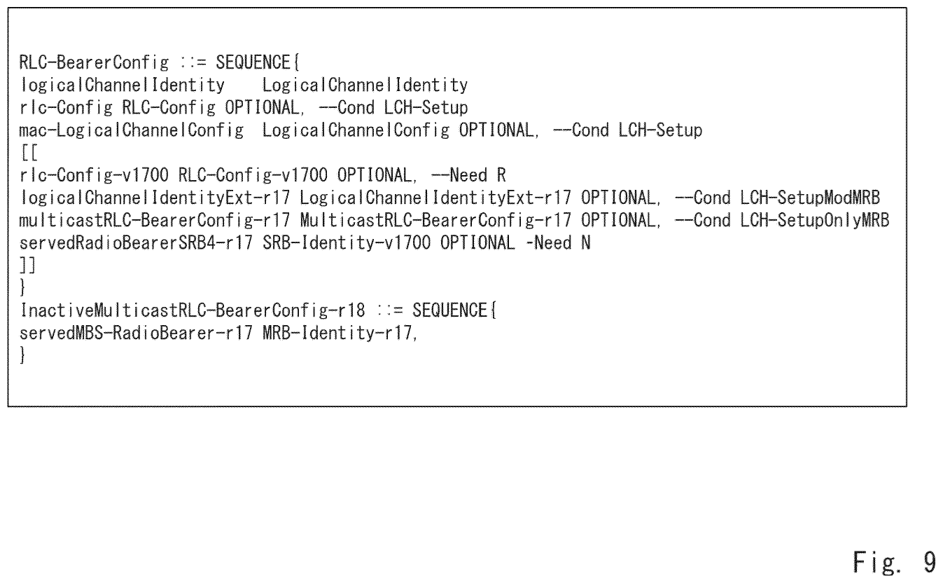

Alternatively, or additionally, an RLC configuration may be used to indicate the PTM to be maintained for the UE 3. For example, an RLC bearer configuration may include an indication that the UE 3 can use the PTM configuration when it is in the RRC inactive state. The indication may also be referred to as a ‘multicast indication’. An example of such a RLC bearer configuration that may be transmitted to the UE 3 is shown in FIG. 8. As shown in FIG. 8, the RLC configuration includes an indication that the UE 3 can use the PTM configuration when it is in the RRC inactive state. In the example of FIG. 9, the indication is ‘INACTIVEPTMIndicator’, which may be, for example: ‘TRUE’ or ‘FALSE’; or similarly, ‘1’ or ‘0’, to indicate whether the UE 3 can use the PTM configuration when it is in the RRC inactive state.

FIG. 9 shows an alternative in which rather than including a separate indication with the list of MBS radio bearers, the multicast RLC bearer configuration for the UE in the inactive state is provided separately (in this example, as ‘InactiveMulticastRLC-BearerConfig-r18’). If InactiveMulticastRLC-BearerConfig-r18 is included in the RLC configuration, then the UE 3 can use the corresponding PTM configuration when the UE 3 is in the RRC inactive state.

### Cell Reselection

When a UE 3 is receiving a multicast service and then performs cell reselection in the RRC inactive state (cell reselection without resuming the RRC connection), it may be possible to continue receiving the multicast service in the new cell. In particular, continuity of the multicast service can be supported if the configuration of the multicast service in the new cell is available to the UE 3 (for example, if the UE 3 has received the configuration of the multicast service in the new cell from the network). If the configuration of the multicast service in the new cell is not available to the UE 3, then the UE 3 may resume the RRC connection (enter the RRC connected state) to obtain the multicast MRB configuration from the network.

Configuration for Multicast when UE is RRC Inactive

As described above, after a UE 3 joins a multicast session the UE 3 can transition from the RRC connected state to the RRC inactive state (e.g. according to any of the methods described above). However, it is possible for the MBS session to become inactive (e.g. due to a base station determining to make the MBS inactive due to a period of data inactivity, or due to there no longer being any UEs 3 in the cell in the RRC connected state). If the MBS session becomes inactive, the UE 3 may determine (e.g. independently of the base station 5) to enter the RRC inactive state in order to reduce power consumption.

There is a problem that when a UE 3 joins a multicast session the MBS configuration from the core network is obtained, but a corresponding MRB configuration is not transmitted to the UE 3 until the multicast session has been activated. However, the UE 3 may need to transition to the RRC connected state from the RRC inactive state in order to receive the configuration for the MRB.

Methods in which the UE enters the RRC connected state and receives an MRB configuration will now be described.

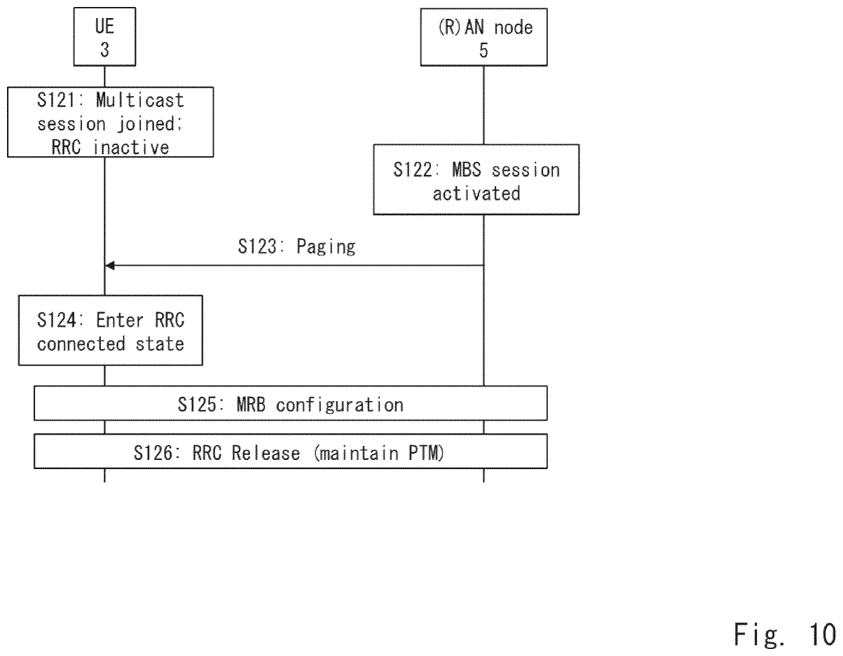

FIG. 10 shows an example in which the UE 3 receives a paging transmission from a (R)AN node 5 (e.g. a base station 5). In step S121 the UE 3 has joined a multicast session and is in the RRC inactive state.

In step S122 the MBS session is activated by the base station 5.

In step S123, the base station 5 transmits a paging transmission to the UE 3.

In step S124, in response to receiving the paging from the base station 5, the UE 5 enters the RRC connected state.

In step S125, when the UE 3 is in the RRC connected state, the UE 3 and the base station 5 communicate in order to provide an MRB configuration for the multicast to the UE 3.

In step S126 an RRC release procedure is performed in order to return the UE 3 to the inactive state (e.g. to reduce power consumption at the UE 3). The RRC release procedure may be, for example, any of the RRC release procedures described above that enable the UE 3 to continue to receive the multicast transmission even after the UE 3 has returned to the RRC inactive state.

Advantageously, in the method illustrated in FIG. 10, the UE 3 is able to obtain the configuration for the multicast despite initially being in the RRC inactive mode, and is able to return to the RRC inactive mode (which beneficially reduces power consumption, and may also reduce congestion in the cell) and continue to receive the multicast transmission at the end of the procedure.

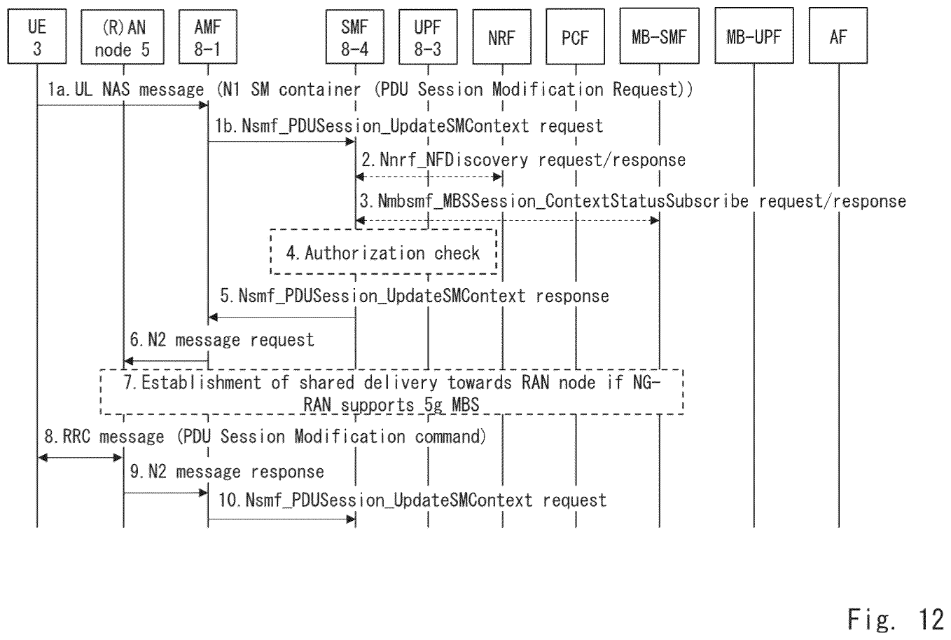

FIG. 12 illustrates a further example in which the UE enters the RRC connected state in order to receive information for receiving a multicast transmission.

The network may activate multiple MBS sessions, and the network may not know which MBS session is to be used for a UE 3 unless the UE 3 provides a corresponding indication to the network. In the present example, a temporary mobile group identity (TMGI) is used to indicate a particular MBS session. The TMGI may be used to identify an MBS bearer service. If the TMGI is not reported by the UE 3 following paging from the base station 5, then the UE 3 may need to report the TMGI via additional signalling (e.g. using an ‘MBSinterestedIndication’ message). This causes additional delay, which is particularly disadvantageous for delay sensitive services. Therefore, it is advantageous to include the indication of the MBS session following the paging (e.g. directly in response to the paging) from the base station 5.

In step S131, when the MBS session is activated, the (R)AN node 5 (e.g. base station 5) transmits a paging message, that includes a TMGI of the MBS session (or a plurality of TMGI), to the UE 3.

In step S132, after reception of the paging from the base station 5, the UE 3 transmits an RRC Resume message to the base station 5. The RRC Resume message includes the TMGI of an MBS service that the UE 3 is to receive.

Advantageously, the provision of the TMGI in the RRC Resume message enables the network to identify the MBS service that the UE 3 is to receive. If the UE 3 does not notify the base station 5 of the TMGI in step S132, then the UE 3 may alternatively perform part (steps 1a to 8) of a multicast session join and session establishment procedure described, for example, in TS 23.247, and described later with reference to FIGS. 12 to 14.

In step S133 an RRC resume procedure is performed, in which the UE 3 enters the RRC connected state.

In step S134, after reception of the TMGI from the UE 3, the network configures a PTM leg for the UE 3. An RRC Reconfiguration message that includes an indication of a corresponding MRB configuration is then transmitted to the UE 3 from the base station 5. Since the UE 3 now has the MRB configuration, the UE 3 is able to receive the multicast from the base station 5.

In step S135 an RRC Release procedure is performed in order to return the UE 3 to the inactive state (e.g. to reduce power consumption at the UE 3). The RRC release procedure may be, for example, any of the RRC release procedures described above.

Advantageously, at the end of the procedure, the UE 3 has the MRB configuration for receiving the multicast, and has returned to the RRC inactive state, reducing power consumption at the UE 3 during the subsequent reception of the multicast.

FIGS. 12 to 14 illustrate a multicast session join and session establishment procedure described in more detail, for example, in TS 23.247 V17.4.0.

In step 1a the UE 3 transmits an uplink (UL) non-access stratum (NAS) message to the AMF 8-1.

In step 1b the AMF 8-1 transmits an Nsmf_PDUSession_UpdateSMContext request to the SMF 8-4.

In step 2, Nnrf_NFDiscovery request/response is transmitted between the SMF 8-4 and the Network Repository Function (NRF).

In step 3, Nmbsmf_MBSSession_ContextStatusSubscribe request/response is transmitted between the SMF 8-4 and the NRF.

In step 4, an authorization check procedure is performed at the SMF 8-4 and the UPF 8-3.

In step 5, a Nsmf_PDUSession_UpdateSMContext response is transmitted from the SMF 8-4 to the AMF 8-1.

In step 6, an N2 message request is transmitted from the AMF 8-1 to the (R)AN node 5.

In step 7, a procedure for establishment of shared delivery towards RAN node if NG-RAN supports 5g MBS is performed.

In step 8, an RRC message (PDU Session Modification command) is exchanged between the UE 3 and the (R)AN node 5.

In step 9, an N2 message response is transmitted from the (R)AN node 5 to the AMF 8-1.

In step 10, an Nsmf_PDUSession_UpdateSMContext request is transmitted from the AMF 8-1 to the SMF 8-4.

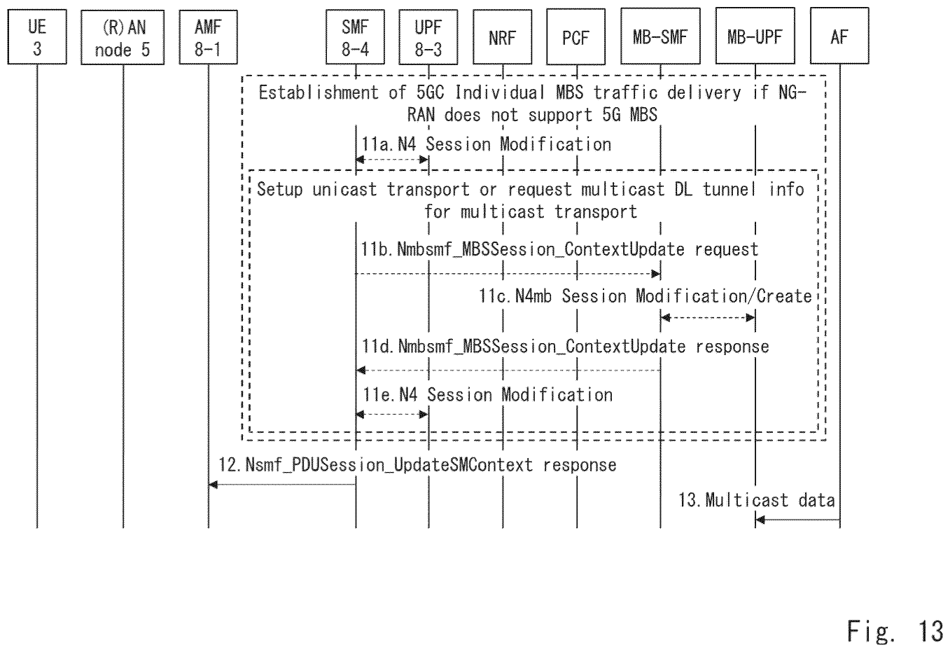

Turning now to FIG. 13, an establishment of 5GC Individual MBS traffic delivery if NG-RAN does not support 5G MBS is shown.

In step 11a, a N4 Session Modification message is exchanged between the SMF 8-4 and the UPF 8-3. A procedure for setup of unicast transport or request multicast DL tunnel info for multicast transport is then performed.

In step 11b, a Nmbsmf_MBSSession_ContextUpdate request is transmitted from the SMF 8-4 to the MB-SMF.

In step 11c, an N4mb Session Modification/Create message is exchanged between the MB-SMF and the MB-UPF.

In step 11d, an Nmbsmf_MBSSession_ContextUpdate response is transmitted from the MB-SMF to the SMF 8-4.

In step 11e, and N4 Session Modification message is exchanged between the SMF 8-4 and the UPF 8-3.

In step 12, an Nsmf_PDUSession_UpdateSMContext response message is transmitted from the SMF 8-4 to the AMF 8-1.

In step 13, multicast data is transmitted from the AF to the MB-UPF.

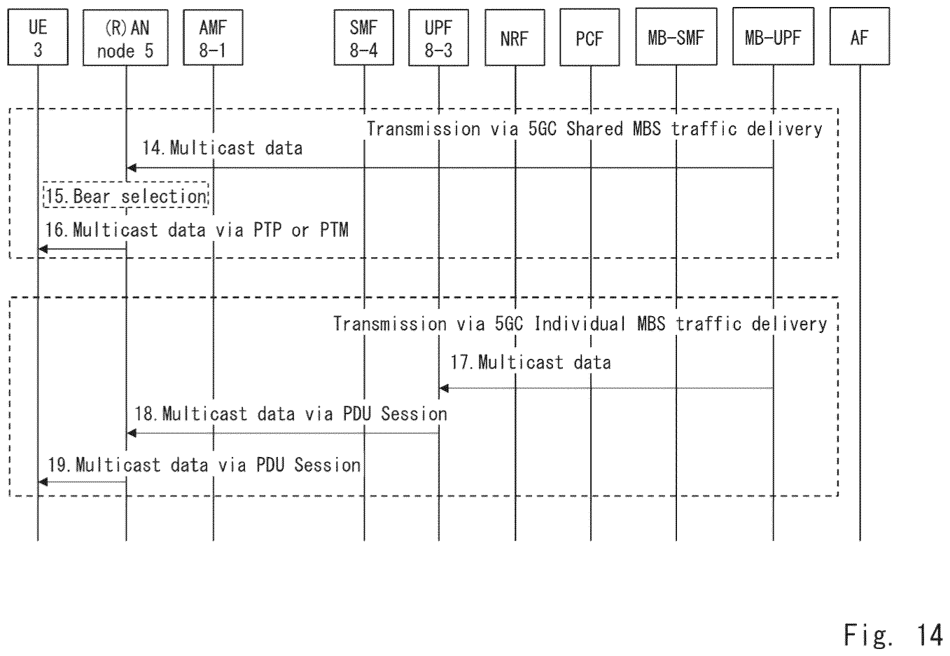

FIG. 14 shows transmission via 5GC Shared MBS traffic delivery. In step 14, the multicast data is transmitted from the MB-UPF to the (R)AN node 5.

In step 15, bearer selection is performed at the (R)AN node 5.

In step 16, multicast data is transmitted from the (R)AN node 5 to the UE 3 via PTP or PTM.

FIG. 14 also shows transmission via 5GC Individual MBS traffic delivery. In step 17, multicast data is transmitted from the MB-UPF to the UPF 8-3.

In step 18, multicast data via PDU session is transmitted from the UPF 8-3 to the (R)AN node 5.

In step 19, multicast data via PDU session is transmitted from the (R)AN node 5 to the UE 3.

### Reducing Occurrence of RRC Connected Mode

Whilst in some of the methods described above it is advantageous for the UE 3 to return to the RRC Connected mode in order to receive information for receiving the multicast (e.g. MRB configuration), it can also be advantageous to reduce the number of times the UE 3 enters the RRC connected state. For example, it is advantageous to avoid a situation in which the multicast configuration changes and causes many UEs to simultaneously enter the RRC connected state to obtain the new configuration, since this may cause congestion on the random access channel (RACH). Advantageously, in this example, a UE 3 does not enter the RRC connected state when the UE 3 already has a configuration for PTM transmission of a multicast.

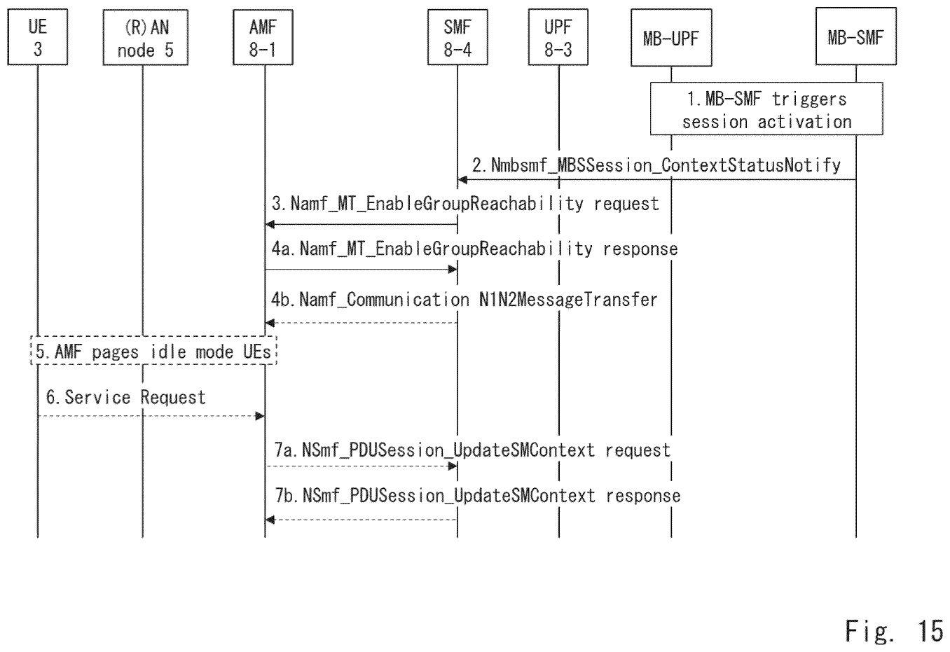

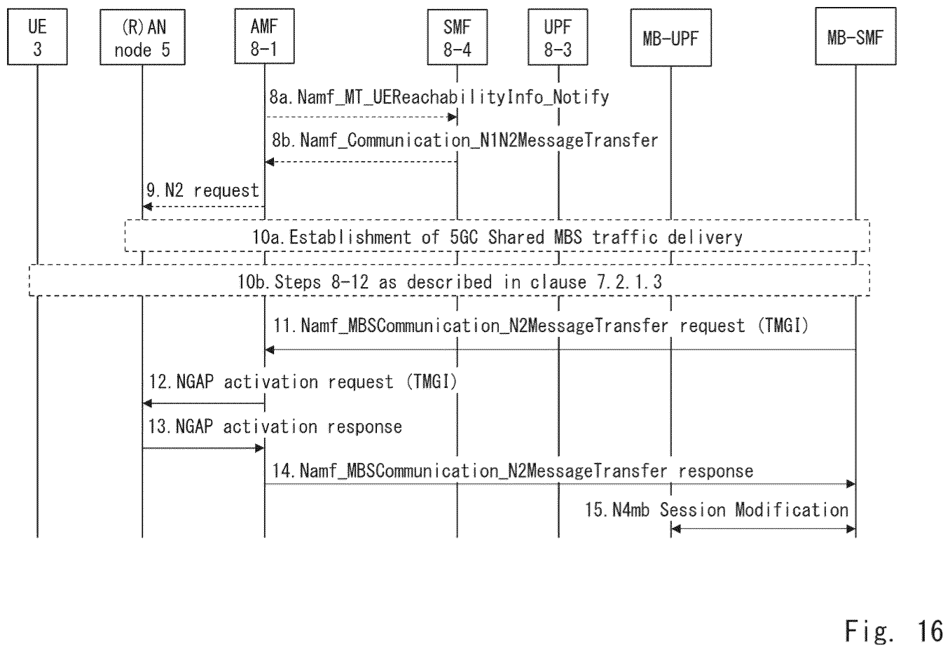

FIGS. 15 and 16 show an MBS session activation and deactivation procedure, described in more detail in TS 23.247 V17.4.0.

In step 1, the MB-SMF triggers session activation.

In step 2, NMBsmf_MBSSession_ContextStatusNotify is transmitted from the MB-SMF to the SMF 8-4.

In step 3, an Namf_MT_EnableGroupReachability request is transmitted from the SMF 8-4 to the AMF 8-1.

In step 4a, an Namf_MT_EnableGroupReachability response is transmitted from the AMF 8-1 to the SMF 8-4.

In step 4b, an Namf_Communication N1N2MessageTransfer is transmitted from the SMF 8-4 to the AMF 8-1.

In step 5, the AMF pages idle mode UEs.

In step 6, a Service Request is transmitted from the UE 3 to the AMF 8-1.

In step 7a, an NSmf_PDUSession_UpdateSMContext request is transmitted from the AMF 8-1 to the SMF 8-4.

In step 7b, an NSmf_PDUSession_UpdateSMContext response is transmitted from the SMF 8-4 to the AMF 8-1.

Turning now to FIG. 16, in step 8a an Namf_MT_UEReachabilityInfo Notify is transmitted from the AMF 8-1 to the SMF 8-4.

In step 8b, an Namf_Communication_N1N2MessageTransfer is transmitted from the SMF 8-4 to the AMF 8-1.

In step 9, an N2 request is transmitted from the AMF 8-1 to the (R)AN node 5.

In step 10a, establishment of 5GC Shared MBS traffic delivery is performed.

In step 10b, steps 8-12 as described in clause 7.2.1.3 of TS 23.247 V17.4.0 are performed.

In step 11, Namf_MBSCommunication_N2MessageTransfer request (TMGI) is transmitted from the MB-SMF to the AMF 8-1.

In step 12, a NGAP activation request (TMGI) is transmitted from the AMF 8-1 to the (R)AN node 5.

In step 13, a NGAP activation response is transmitted from the (R)AN node 5 to the AMF 8-1.

In step 14, an Namf_MBSCommunication_N2Message Transfer response is transmitted from the AMF 8-1 to the MB-SMF.

In step 15, a N4mb Session Modification message is exchanged between the MB-UPF and the MB-SMF.

In step 12 of the procedure shown in FIG. 16, the AMF 8-1 transmits an NGAP activation request message to the (R)AN node 5, and the UE 3 subsequently receives paging from the (R)AN node 5 so that the UE 3 can receive a corresponding configuration for PTM. In a situation in which a UE 3 has joined an MBS session but is now in the RRC inactive state, if the UE 3 has been configured with the PTM configuration before entering the RRC inactive state then the UE 3 does not need to enter the RRC connected state to obtain a PTM configuration. However, the UE 3 may enter the RRC connected state in response to receiving the paging from the (R)AN node 5. Improved methods in which the UE 3 does not enter the RRC connected state if the PTM configuration is available at the UE 3 will now be described.

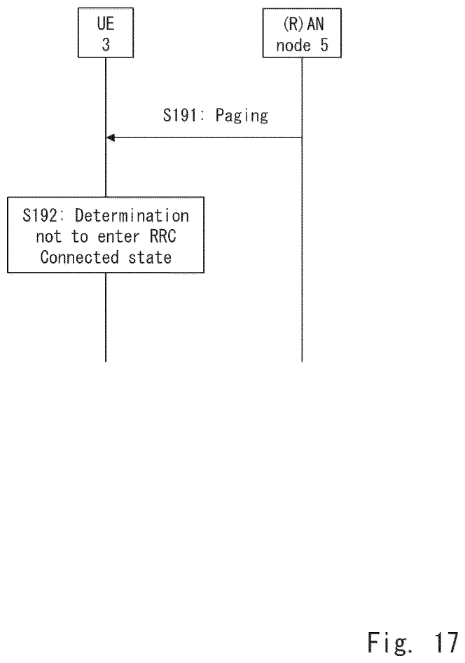

FIG. 17 shows an example in which the UE 3, after having receiving paging from the (R)AN node 5, does not enter the RRC connected state if a PTM configuration is available at the UE 3. It will be appreciated that the paging in FIG. 17 need not necessarily be the paging corresponding to the method illustrated in FIGS. 15 and 16, and that the paging may be any other suitable paging from the (R)AN node 5. More generally, the (R)AN node 5 may determine to transmit a transmission to the UE 3 for causing the UE 3 to enter the RRC connected state so that a configuration for PTM can be received, but in the present example the UE 3 will advantageously nevertheless remain in the RRC inactive state if the UE 3 already has the configuration for PTM available (e.g. stored) at the UE 3.

In step 191 paging is transmitted from the (R)AN node 5 to the UE 3. The paging may be for causing the UE 3 to enter the RRC connected state so that a configuration for PTM can be transmitted from the (R)AN node 5 to the UE 3.

In step 192, the UE 3 determines not to enter the RRC Connected state, even though the paging has been received from the (R)AN node 5. The UE 3 may determine not to enter the RRC Connected state based on information for multicast stored at the UE 3 (e.g. a MRB configuration for PTM stored at the UE 3). Advantageously, therefore, the UE 3 does not unnecessarily transition to the RRC Connected state, reducing the power consumption and the UE 3 and reducing the risk of network congestion.

Alternatively, the (R)AN node 5 may determine that the UE 3 already has the PTM configuration available at the UE 3, and may determine not to transmit the paging to the UE 3. The (R)AN node 5 may determine that the UE 3 already has the PTM configuration, for example, based on a PTM configuration previously transmitted from the (R)AN node 5 to the UE 3. If the (R)AN node 5 is not the same (R)AN node 5 that previously transmitted the PTM configuration to the UE 3, then the (R)AN node 5 may receive an indication from the network that the UE 3 already has the PTM configuration, and determine not to transmit corresponding paging to the UE 3.

### DCI and HARQ Scheduling Information

In wireless communications some of the transmitted packets may be lost, or may be subject to errors introduced by noise or interference. The Hybrid Automatic Repeat Request (HARQ) procedure can be used to mitigate against such packet losses and errors by using re-transmission (or selective re-transmission) of data packets. For example, a UE 3 may receive a transmission from a base station 5 that includes errors or missing packets. The UE 3 may attempt to correct errors in the received transmission, where possible, and may provide feedback to the base station 5 regarding the transmission that has been received, for example including an acknowledgement (ACK) or negative acknowledgement (NACK). Based on the feedback, the base station 5 may re-transmit some or all of one or more original transmissions.

The HARQ procedure may include a number of simultaneous HARQ processes, each used for a respective part of the transmission. Therefore, when the base station is awaiting feedback from the UE 3 corresponding to a particular HARQ process (and therefore to a particular part of the transmission), the base station 5 can continue transmission of data for the other HARQ processes.

Information regarding the HARQ processes (e.g. a HARQ configuration), such as the time and frequency resources for use by the UE 3 to transmit the HARQ acknowledgements, can be provided to the UE 3 using downlink control information (DCI), as described in more detail below. The DCI may include, for example, a dedicated bit (or bits) for indicating whether HARQ feedback is to be enabled (or disabled) for a particular HARQ process.

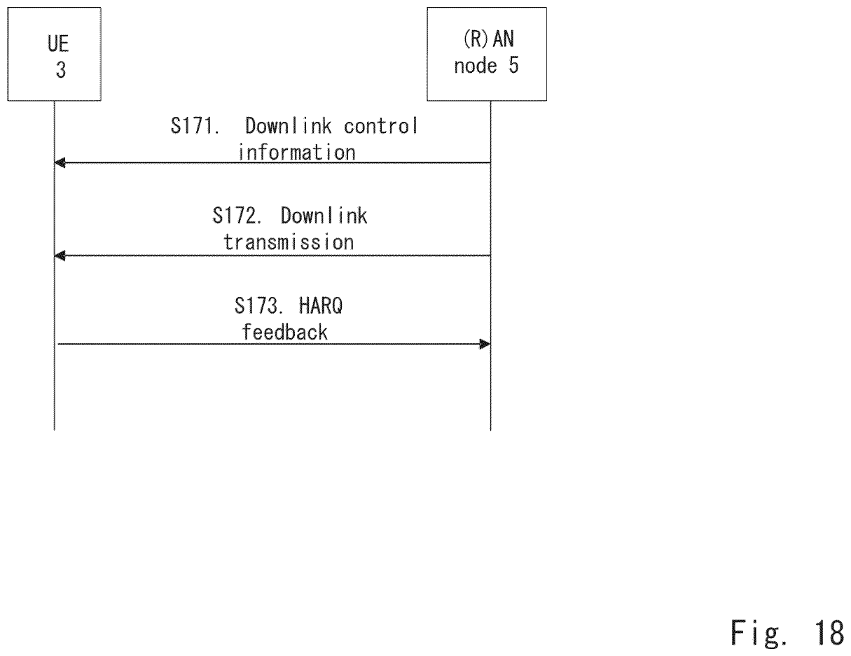

An example of a method in which a UE 3 transmits HARQ feedback based on DCI is illustrated in FIG. 18. In step S171 the UE 3 receives DCI from the base station 5. The DCI includes HARQ configuration information for at least one HARQ process. In step S172, the base station transmits a corresponding downlink transmission to the UE 3. In step S173, the UE 3 transmits HARQ feedback to the base station 5 based on the HARQ configuration information received in the DCI from the base station 5 in step S171.

The present inventors have realised that during transitions of a UE 3 between the RRC connected and RRC inactive states, continuity of an MBS service can be improved by providing improved methods in which DCI is transmitted to the UE 3 in the RRC connected and RRC inactive states. Types of DCI that may be transmitted from the base station 5 to the UE 3 will now be described in more detail.

### DCI 4_0

DCI format 4_0 is used for the scheduling of PDSCH for broadcast in a cell. In other words, DCI format 4_0 is a DCI for broadcast. DCI format 4_0 may alternatively simply be referred to as DCI 4_0.

DCI 4_0, and corresponding PDCCH configurations, may be used to transmit a broadcast to a UE 3 in the RRC connected state, RRC inactive state, or RRC idle state.

DCI 4_0 may be transmitted with a cyclic redundancy check scrambled by MBMS point-to-multipoint Control Channel (MCCH) radio network temporary identifier (RNTI), MCCH-RNTI, or group-RNTI (G-RNTI) for a multicast traffic channel (MTCH) configured by MBS session information (e.g. MBS-SessionInfo).

DCI 4_0 includes a frequency domain resource assignment—

$$⌈ {log}_{2} ( {N}_{RB}^{DL , CFR} ( {N}_{RB}^{DL , CFR} + 1 ) / 2 ⌉$$

bits, where

$${N}_{RB}^{DL , CFR}$$

is equal to the size of CORESET 0 if CORESET 0 is configured for the cell, and is equal to the size of the initial DL bandwidth part of CORESET 0 is not configured for the cell.

DCI 4_0 includes a time domain resource assignment. The time domain resource assignment is used to indicate a slot offset, PDSCH mapping type, starting symbol, and number of allocated symbols. This information may be indicated using a lookup table (the time domain resource assignment may comprise a pointer to a lookup table).

DCI 4_0 includes a virtual resource block (VRB) to physical resource block (PRB) mapping. The VRB to PRB mapping is a field used to indicate whether the PDSCH uses a non-interleaved VRB to PRB mapping, or an interleaved VRB to PRB mapping. In a non-interleaved mapping, an index for a particular VRB is mapped to a PRB having the same index. In an interleaved mapping, a function is used to map the index for a particular VRB to the corresponding PRB index.

DCI 4_0 includes an indication of a modulation and coding scheme (MCS), which may be in the form of a pointer to a lookup table.

DCI 4_0 includes a redundancy version (RV) that indicates a corresponding puncturing pattern.

DCI 4_0 includes an MCCH change notification if the CRC of DCI 4_0 is scrambled by MCCH-RNTI.

It will be appreciated that a modified version of DCI 4_0 may be used in which some of the above described information (such as the MCCH change notification) is omitted where appropriate.

In contrast to DCI 4_1 and DCI 4_2 described below, DCI 4_0 does not include fields indicating HARQ scheduling information for UEs 3 in the RRC connected state. For example, DCI 4_0 does not include a new data indicator (NDI), HARQ process number, or an indication of HARQ frequency or time resources.

### DCI 4_1

DCI format 4_1 (and corresponding PDCCH configurations) is used for multicast transmission. DCI format 41 may alternatively simply be referred to as DCI 4_1.

The same transmission configuration index (TCI) state as the TCI state for unicast PDCCH may be used when DCI 4_1 is used.

DCI 4_1 includes a frequency domain resource assignment, time domain resource assignment, VRB to PRB mapping, MCS and RV as described above for DCI 4_0.

DCI 4_1 also includes a HARQ process number that indicates a corresponding HARQ process.

DCI 4_1 may include a new data indicator (NDI) that is used to indicate if the resource allocation is for a retransmission, or for a new transmission.

DCI 4_1 includes a PUCCH resource indicator that indicates that the UE 3 is to use a particular PUCCH resource when returning HARQ acknowledgements. If the UE 3 has been configured with dedicated PUCCH resources, then the PUCCH resource indicator may indicate one of those resources. The PUCCH resource indicator may be in the form of a 3-bit field.

DCI 4_1 includes a PDSCH to HARQ feedback timing indicator that indicates the number of slots between reception of the PDSCH and transmission of HARQ feedback. The PDSCH to HARQ feedback timing indicator may be in the form of a 3-bit field.

It will be appreciated that a modified version of DCI 4_1 may be used in which some of the above described information is omitted, where appropriate.

### DCI 4_2

DCI format 4_2 is used for the scheduling of PDSCH. DCI format 4_2 may alternatively simply be referred to as DCI 4_2. DCI 4_2 for multicast MBS includes a TCI state for PDSCH reception.

DCI 4_2 may be transmitted with a cyclic redundancy check scrambled by G-RNTI, configured by G-RNTI configuration information (e.g. G-RNTI-Config), or group-configured scheduling-RNTI (G-CS-RNTI).

DCI 4_2 includes a frequency domain resource assignment, time domain resource assignment, VRB to PRB mapping, PRB bundling size indicator, rate matching indicator, zero power channel status information reference signal (ZP-CSI-RS) trigger, HARQ process number, downlink assignment index, PUCCH resource indicator, PDSCH-to-HARQ feedback timing indicator, and indication of antenna ports, a transmission configuration indication, a demodulation reference signal (DMRS) sequence initialization, priority indicator and enabling/disabling HARQ-ACK feedback indication (in which a value of 1 indicates enabling HARQ-ACK feedback and a value of 0 indicates disabling HARQ-ACK feedback).

It will be appreciated that a modified version of DCI 4_2 may be used in which some of the above described information is omitted, where appropriate.

The size of DCI 42 is configurable and may be, for example, between 20 bits and 140 bits.

DCI 4_0, DCI 4_1 and DCI 4_2 are described in more detail in 3GPP TS 38.212 V17.3.0.

### RRC Release

Some elements of the RRC release procedure will now be described in more detail. Upon reception of an RRC release message by the UE 3, the UE 3: resets MAC and releases the default MAC cell group configuration, if any; re-establishes RCL entities for signalling radio bearer 1 (SRB1); suspends all of one or more SRBs and data radio bearers (DRBs) and one or more multicast MRBs, except signalling radio bearer 0 (SRB0); indicates packet data convergence protocol (PDCP) suspend to lower layers of all DRBs and multicast MRBs; and indicates suspension of the RRC connection to upper layers. The UE 3 enters the RRC inactive state and performs cell selection.

After receiving an RRC release message the UE 3 also flushes one or more buffers corresponding to DL HARQ processes, except for a DL HARQ process being used for MBS broadcast. The UE 3 considers, for each DL HARQ process, the next received transmission for a transport block (TB) to be the first transmission.

When an upper layer requests an RLC entity re-establishment, the UE 3: discards all RLC service data units (SDUs), RLC SDU segments, and RLC protocol data units (PDUs), if any; stops and resets all timers; and resets all state variables to their initial values.

When an upper layer requests a PDCP entity suspend, the receiving PDCP entity: stops and reset a reordering timer; and delivers all stored PDCP SDUs to the upper layers in ascending order of associated count values, after performing header decompression.

The present inventors have realised that multicast reception may be interrupted (no service reception continuity) during a transition of a UE 3 from the RRC connected state to the RRC inactive state, due to the HARQ buffer flush, MAC reset, RLC re-establishment and PDCP suspension. However, for an MBS multicast there may be a service continuity requirement (for example, when the MBS is for a public safety oriented service). Improved methods that mitigate against this issue when a UE 3 transitions from the RRC connected state to the RRC inactive state are described later.

### RRC Resume

Some elements of the RRC resume procedure will now be described in more detail. Upon reception of an RRC resume message, the UE 3 performs cell group configuration for a receives master cell group (e.g. masterCellGroup), including both RLC re-establishment/RLC establishment, and MAC configuration. If the RRC resume message includes a radio bearer configuration, then the UE 3 performs the radio bearer configuration. If signalling radio bearer 2 (SRB2) is suspended, then the UE 3 resumes SRB2. The UE 3 also resumes SRB3 and SRB 4, if configured. The UE 3 also resumes all suspended DRBs and multicast MRBs. The UE 3 may also re-establish the PDCP entity of the multicast MRB.

When upper layers request an RLC entity establishment, the UE 3 establishes an RLC entity, and sets the state variables of the RLC entity to initial values.

When upper layers request an RLC entity re-establishment, the UE 3 discards all RLC SDUs, RLC SDU segments and RLC PDUs, if any. The UE 3 stops and resets all timers, and resets state variables to their initial values. For UM DRBs and UM MRBs, the UE 3 delivers all stored PDCP SDUs to the upper layers in ascending order of associated count values, after performing header decompression. For AM DRBs and AM MRBs for the Uu interface, the UE 3 may perform header decompression using robust header compression (ROHC) for all stored PDCP SDUs. For UM DRBs, AM DRBs, UM MRBs and AM MRBs, the UE 3 may reset the ROHC protocol for downlink and starts with a no context (NC) state in unidirectional mode (U-mode) in which packets are sent in one direction only (from the compressor to the decompressor).

The present inventors have realised that multicast reception may be interrupted (no service reception continuity) during a transition of a UE 3 from the RRC inactive state to the RRC connected state due to the MAC configuration, RLC establishment/re-establishment and PDCP re-establishment. However, for an MBS multicast there may be a service continuity requirement (for example, when the MBS is for a public safety oriented service). Improved methods that mitigate against this issue when a UE 3 transitions from the RRC inactive state to the RRC connected state are described later.

### Multicast Transmissions and Group Common PDSCH

The PDSCH is used to transfer end-user application data, signalling radio bearer (SRB) messages, system information and paging messages. Group common PDSCH (GC-PDSCH) is a PDSCH that is transmitted for reception by a corresponding group of UEs 3.

In a cell of the communication network there may be one or more UEs 3 in the RRC connected state and one or more UEs 3 in the RRC inactive state. DCI transmitted to the UEs 3 in the RRC connected state (e.g. DCI 4_1 or DCI 4_2) can include HARQ scheduling information such as the NDI, HARQ process number, HARQ feedback time resources, and HARQ feedback frequency resources. DCI used to schedule multicast transmissions for UEs 3 in the RRC inactive state need not carry HARQ scheduling information in a case where the network assumes no HARQ feedback for these UEs 3. A single MBS multicast cell supports multicast transmissions to UEs 3 in both the RRC connected state and the RRC inactive state. Two different types of DCI can be used to schedule the multicast transmissions; one type of DCI for the UEs in the RRC connected state and one type of DCI for the RRC inactive state.

A common identifier, Group-RNTI (G-RNTI), can be used to group and identify a group of UEs 3 that are camping on a cell. The use of G-RNTI enables more flexible scheduling for unicast and multicast data within the PDSCH channel. A single DCI can be transmitted to a group of UEs 3, based on the G-RNTI, for reception of particular downlink transmissions by those UEs 3. The use of the G-RNTI to identify a group of UEs 3 (rather than individual UEs 3) reduces the PDCCH overhead. For a multicast, UEs that have joined a particular MBS session can be configured with the same G-RNTI to receive the MBS session.

Methods in which a UE 3 continues to receive a multicast transmission when the UE 3 transitions from an RRC connected state to an RRC inactive state (or transitions from an RRC inactive state to an RRC connected state) have been described above. Particularly advantageous methods of improving MBS continuity (e.g. reducing interruptions in reception of the MBS by the UE 3) when the UE 3 transitions from the RRC connected state to the RRC inactive state (or from the RRC inactive state to the RRC connected state) will now be described. Whilst the below-described methods for improving MBS continuity may be applied to any of the above-described methods where appropriate, it will be appreciated that the improved methods described below are not limited to being applied to the above-described methods, and may alternatively be applied to any other suitable method in which the UE 3 transitions from the RRC connected state to the RRC inactive state (or from the RRC inactive state to the RRC connected state).

### Same GC-PDSCH

Examples in which the same GC-PDSCH is used for MBS multicast transmissions for both UEs in the RRC connected state and UEs 3 in the RRC inactive state will now be described. In this case, the HARQ scheduling information, if provided, is common to both the RRC connected UEs 3 and the RRC inactive UEs 3.

### No HARQ Scheduling Information

In a first option, no HARQ scheduling information is provided. In this case, either a single DCI or two different DCI may be used to schedule the multicast transmissions for the GC-PDSCH. For example, both the RRC connected UEs 3 and the RRC inactive UEs 3 use a single HARQ process to receive the multicast transmissions. During a state transition between the RRC connected state and the RRC inactive state, the UE 3 maintains (keeps) the HARQ process (an identifier of the HARQ process used by the UE does not change when the UE transitions from the RRC connected state to the RRC inactive state) and does not flush the corresponding HARQ buffer (which may be a so-called ‘soft buffer’). Advantageously, by virtue of maintaining the HARQ process and not flushing the corresponding HARQ buffer, continuity of reception of the multicast is improved when the UE 3 transitions between the RRC connected state and the RRC inactive state.

### Multiple HARQ Processes for RRC Inactive UE

A further improved method in which HARQ scheduling information is provided, to increase the reliability of the transmission of the transport blocks (TBs) over the air interface to the UE 3, will now be described. In this example, HARQ scheduling information including NDI, HARQ process ID, HARQ feedback resources and HARQ timing resources (or any other suitable HARQ information, as described above for example with reference to DCI 4_1 and DCI 4_2) is provided. Advantageously, in addition to the RRC connected UEs 3, the RRC inactive UEs 3 are also able to use the same set of multiple HARQ processes to receive the multicast transmissions, and may make use of HARQ retransmissions even when the RRC inactive UEs 3 do not transmit HARQ feedback.

In this example, the RRC connected UEs 3 that are receiving the multicast use HARQ scheduling information provided in DCI received from the base station 5 (e.g. DCI 4_1 or DCI 42). The RRC connected UEs 3 may transmit HARQ feedback to the base station 5 based on the HARQ configuration information included in the DCI. The RRC inactive UEs 3 also receive the downlink data that is transmitted using the HARQ processes. Advantageously, the RRC inactive UEs use the NDI and HARQ process numbers indicated in the DCI to receive and process the downlink transmissions. For example, the RRC inactive UEs 3 can determine, using the NDI, whether the downlink transmission corresponds to new data or is a retransmission. The RRC inactive UEs 3 may be configured not to transmit HARQ feedback, (in which case the RRC inactive UEs 3 may ignore the HARQ feedback frequency and time resources provided in the DCI). In this case, HARQ retransmission by the base station 5 that is providing the MBS multicast cell is based on the feedback from the RRC connected UEs 3 (e.g. a NACK), since the RRC inactive UEs 3 do not transmit HARQ feedback. However, since the RRC inactive UEs 3 are receiving the multicast using the same HARQ processes, the RRC inactive UEs 3 may still receive HARQ retransmissions. An RRC inactive UE 3 may be configured to simply ignore a received multicast HARQ retransmission if the UE 3 has already successfully received and decoded the corresponding transport block. However, advantageously, in this example if the UE 3 has not successfully received and decoded the transport block corresponding to the HARQ retransmission, then the UE 3 may use (receive and process) the received HARQ retransmission. For example, the UE 3 may instruct the physical layer to combine the received HARQ retransmission with data currently in a buffer for the corresponding transport block, and attempt to decode the combined data. Beneficially, therefore, the UE 3 is able to make use of the HARQ retransmissions, improving the reliability of the MBS multicast reception over the air interface, even when the UE 3 is in the RRC inactive state and is not transmitting HARQ feedback.

### Single HARQ Process for RRC Inactive UE

An example in which an RRC inactive UE 3 receives downlink data using one HARQ process will now be described. In this example, as with the example described above in which Multiple HARQ processes are used, HARQ scheduling information including NDI, HARQ process ID, HARQ feedback resources and HARQ timing resources (or any other suitable HARQ information, as described above for example with reference to DCI 4_1 and DCI 4_2) is provided. However, in this example, a single HARQ process is used. The RRC connected UEs 3 may transmit HARQ feedback to the base station 5 based on the HARQ configuration information included in the DCI of the single HARQ process. The RRC inactive UEs 3 also receive the downlink data that is transmitted using the HARQ process. In this example, rather than identifying retransmissions, the RRC inactive UE 3 attempts to decode each received transport block for the multicast, and delivers it to the MAC layer if the transport block was successfully decoded. Since in this example the UE 3 does not identify whether a transmission is a new data transmission or a re-transmission (since the same PDSCH is used for the RRC connected UEs 3 and the RRC inactive UEs 3, and the inactive UE 3 did not request a retransmission), duplicate transport blocks may be delivered to the MAC layer of the UE 3. However, layer 2 (L2) protocol functions can be used to remove the duplicate transport blocks. Advantageously, in this example operation of the RRC inactive UE 3 is simplified, since the RRC inactive UE 3 need only be configured for reception of data using a single HARQ process.

### Different GC-PDSCH

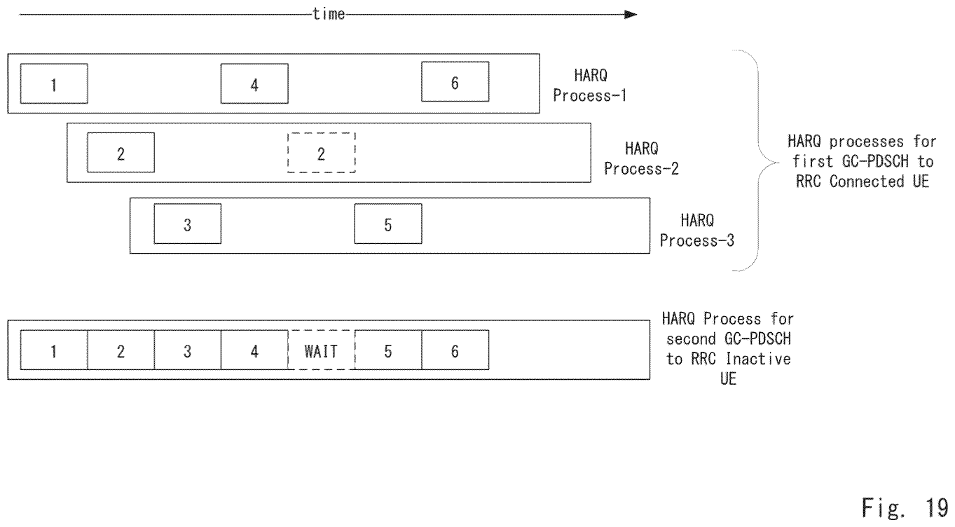

An example in which the GC-PDSCH used for the RRC connected UEs 3 is different from the GC-PDSCH used for the RRC inactive UEs 3 will now be described with reference to FIG. 19, which shows three HARQ processes corresponding to a first GC-PDSCH for one or more RRC connected UEs 3, and a further HARQ process for a second GC-PDSCH for one or more RRC inactive UEs 3. Transport blocks 1 to 6 that are transmitted using the HARQ processes are also illustrated. As shown in FIG. 19, HARQ process-2 includes an initial transmission of transport block 2 indicated by the solid box, and a retransmission of transport block 2 indicated by the dashed box.

The two GC-PDSCH are scheduled using respective DCIs. For example, DCI 4_0 may be used for the GC-PDSCH for the RRC inactive UE 3, and DCI 4_1 or 4_2 may be used for the GC-PDSCH for the RRC connected UE 3. The two GC-PDSCH may be frequency division multiplexed (FDM), time division multiplexed (TDM), or both. Advantageously, in this example, a UE 3 may receive both of the GC-PDSCH (e.g. simultaneously, or substantially simultaneously), improving MBS multicast service continuity when the UE 3 transitions from an RRC connected state to an RRC inactive state (or from an RRC inactive state to an RRC connected state).

HARQ scheduling information may be provided to the RRC connected UEs 3 using the DCI for the HARQ processes for the corresponding GC-PDSCH (in this example, HARQ process-1 to HARQ process-3 shown in FIG. 19).

As illustrated in FIG. 19, transport blocks for both of the GC-PDSCH can be delivered in a duplicated and synchronised manner from the network to the UE 3. In other words, a particular transport block that is constructed based on the MAC PDU can be transmitted over the air interface by the base station 5 using both GC-PDSCH at approximately the same time (or exactly, or substantially, the same time). For example, as shown in FIG. 19, transport block 3 is transmitted at approximately the same time in the first GC-PDSCH and the second GC-PDSCH. This synchronisation can advantageously be maintained even when HARQ feedback and HARQ retransmission is used for the GC-PDSCH for the RRC connected UEs 3 (the first GC-PDSCH in FIG. 19). For example, as shown in FIG. 19, HARQ process-2 includes a retransmission of transport block 2, indicated by the dashed line. The retransmission may be caused by one of the RRC connected UEs 3 transmitting a NACK corresponding to transport bock 2 to the base station 5. In order to maintain the synchronisation between the first GC-PDSCH and the second GC-PDSCH, in this example no transport block is transmitted using the second GC-PDSCH during the time period in which the re-transmission is occurring for the first GC-PDSCH. Following the HARQ retransmission in HARQ process-2, the method proceeds to HARQ process-3 and the HARQ process for the second GC-PDSCH, which are both used to transmit transport block 5 (the next transport block in the sequence), maintaining the syncronisation between the first and second GC-PDSCH.

Whilst in the example of FIG. 19 the second GC-PDSCH includes a waiting period whilst the re-transmission of transport block 2 takes place, this need not necessarily be the case. Alternatively, the duplicated transmission may be performed at the PDCP and/or RLC layer. In other words, two different RLC entities may be established to support the transmission at the two GC-PDSCH, in which case synchronised transmission of the transport blocks is not required.

### DCI/HARQ Switch

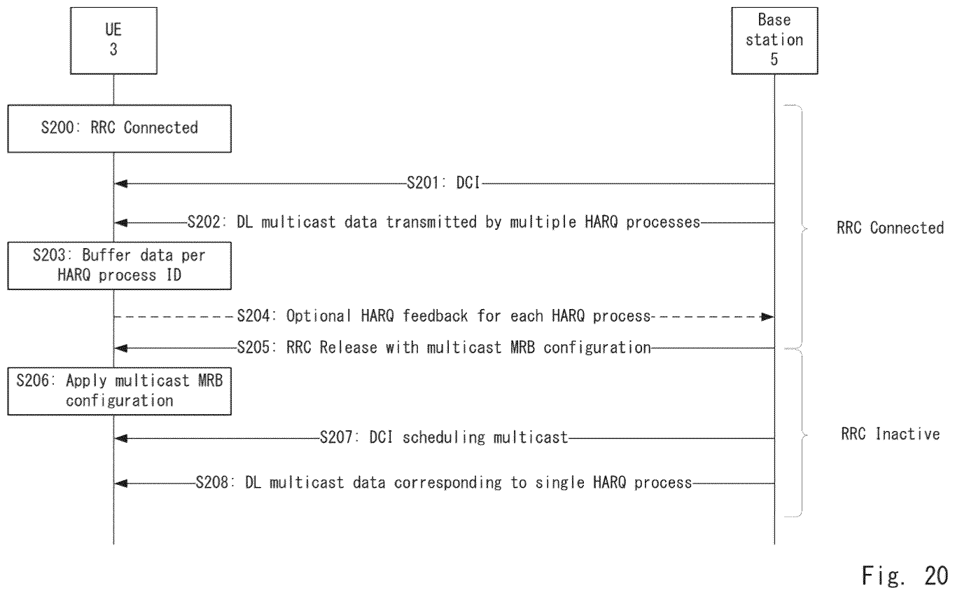

An example in which DCI is switched to a different format will now be described with reference to FIG. 20. During a transition of a UE 3 between the RRC connected and the RRC inactive states, the DCI can be switched to support reception of the multicast after the transition has occurred. In this example new DCI and a corresponding PDCCH configuration are indicated to the UE 3 using an RRC release message transmitted from the base station 5 to the UE 3 (however, any other suitable transmission from the base station 5 to the UE 3 could alternatively be used).

As described above, DCI for reception of the multicast when the UE 3 is in the RRC inactive state need not necessarily include HARQ scheduling information for HARQ feedback. Multiple HARQ processes may be used to provide the multicast when the UE 3 is in the RRC connected state, and a single HARQ process may be used to provide the multicast when the UE 3 is in the RRC inactive state.

In this example, the DCI (e.g. DCI 4_1 or DCI 4_2) for the UEs in the RRC connected state includes a corresponding HARQ process number, and the multicast reception is based on multiple HARQ processes (each associated with a corresponding HARQ buffer). If the DCI is switched to a new format or a format used for a broadcast (e.g. DCI 4_0), then the HARQ process number is not indicated, and a single HARQ process can be assumed by the UE 3. In this case, the previous HARQ buffers can be flushed (emptied or overwritten) at the UE 3, and the corresponding HARQ processes can be released. A new HARQ process is used for the subsequent multicast reception.

As shown in FIG. 20, in step S200 a UE 3 is initially in an RRC connected state. In step S201 the UE 3 receives DCI (e.g. DCI 4_1 or DCI 4_2) for HARQ processes, for receiving a corresponding MBS multicast.

In step S202 the UE 3 receives the DL multicast data transmitted using the multiple HARQ processes.

In step S203 the UE 3 stores the received data in a separate buffer for each HARQ process ID.

In optional step S204, the UE 3 transmits HARQ feedback for the HARQ processes to the base station 5. It will be appreciated that the HARQ feedback can be configured based on the DCI received in step S201 (or the DCI may include an indication that HARQ feedback is not required).

In step S205 the base station transmits an RRC release message to the UE 3, for example after a determination by the base station that the UE 3 is to enter the RRC inactive state (e.g. due to high RRC load). The RRC release message includes an indication of a multicast MRB configuration. Following reception of the RRC release message, the UE 3 transitions from the RRC connected state to the RRC inactive state.

In step S206 the UE 3 is in the RRC inactive state and applies the multicast MRB configuration received from the base station 5.

In step S207 the base station 5 transmits DCI corresponding to the new multicast MRB configuration to the UE 3. In this example, a single HARQ process is used for the UE 3 in the RRC inactive state.

In step S208, the UE 3 receives the DL multicast data corresponding to the single HARQ process, and therefore continues to receive the multicast.

Advantageously, by virtue of the multicast MRB configuration information (which may also be referred to simply as multicast configuration information, or DCI configuration information) included in the RRC release message, in the method illustrated in FIG. 20 the UE 3 is able to continue to receive the MBS multicast even after the UE 3 has transitioned to the RRC inactive state. The UE 3 transitions from receiving the multicast using multiple HARQ processes whilst in the RRC connected state, to receiving the multicast using a single HARQ process whilst in the RRC inactive state.

The method illustrated in FIG. 20 may also be applied to any of the methods of using multiple HARQ processes or a single HARQ process to provide an MBS multicast that have been described above, where appropriate.

Whilst the method of FIG. 20 has been described with reference to the RRC Release procedure and a transition of the UE 3 from the RRC connected state to the RRC inactive state, the DCI may also be switched as part of a transition from the RRC inactive state to the RRC connected state. For example, the new multicast MRB configuration may be provided to the UE 3 from the base station as part of the RRC resume procedure. The UE 3 may switch from receiving the multicast via a single HARQ process whilst the UE 3 is in the RRC inactive state, to receiving the multicast via a plurality of HARQ processes when the UE 3 is in the RRC connected state.

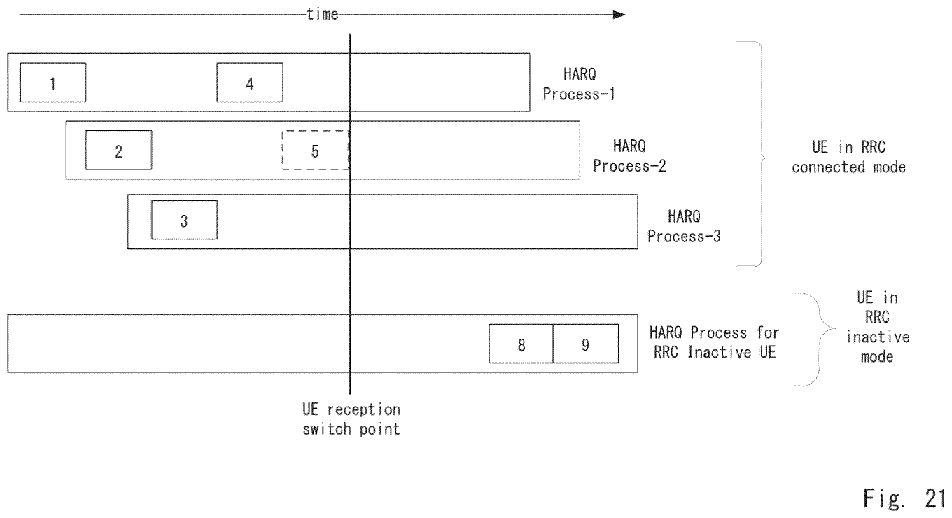

Whilst the method of FIG. 20 advantageously enables the UE 3 to continue reception of the MBS multicast after a transition to the RRC inactive state, FIG. 21 shows an example of a situation that may occur in which one or more transport blocks may not be received and decoded by the UE 3. This situation may occur when the method of FIG. 20 is used and the DCI switch coincides with a failure to successfully receive and decode a transport block. In the example illustrated in FIG. 21, transport block 5 is not successfully received and decoded (indicated by the dashed box), and a corresponding NACK is transmitted from the UE 3 to the base station. However, in this example the DCI switch occurs shortly after the failure to decode transport block 5. Due to the switch to the new MRB configuration, transport blocks that are not successfully decoded are removed from the HARQ buffer and are not submitted to the MAC layer. In this example, this results in the UE 3 failing to successfully receive and decode transport block 5. Moreover, in this example, due to the time taken to switch to the new DCI/HARQ-process, transport blocks 6 and 7 are also not received by the UE 3. A further improved method in which an early DCI switch is used to mitigate against these issues will now be described.

### Early Switch

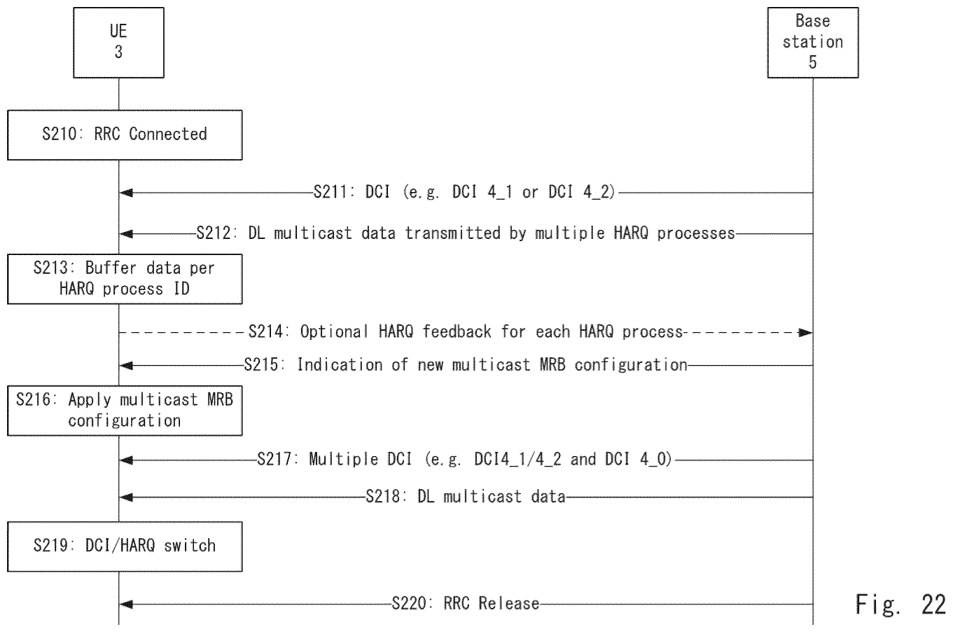

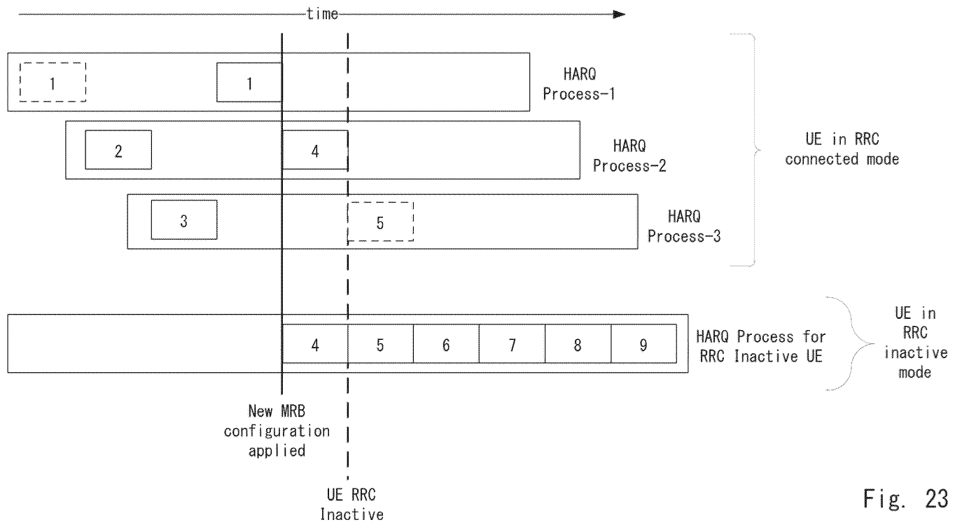

An example in which the new DCI and the corresponding PDCCH configuration are provided to the UE 3 before the UE 3 is released to the RRC inactive state will now be described with reference to FIGS. 22 and 23. Advantageously, the method enables transport blocks of the multicast to be more reliably received and decoded at the UE 3, improving the continuity of the MBS multicast when the UE 3 transitions from the RRC connected state to the RRC inactive state.

In this example the UE 3 is configured to monitor two different DCI simultaneously, and maintain two multicast data receptions using two separate buffers (or two separate sets of buffers). However, only one copy of the received data (e.g. received transport blocks) is submitted to the MAC layer (alternatively, duplicate transport blocks could be removed using suitable L2 processing). Advantageously, the method illustrated in FIGS. 22 and 23 avoids the switch delay between the two configurations (including the RRC message parsing delay that may occur in the example of FIG. 20), and avoids the gap in transport block reception caused by decoding failure illustrated in FIG. 21.

Turning now to FIG. 22, in step S210 the UE 3 is in the RRC connected state. Steps 211 to 214 are the same as for steps S201 to S204 of FIG. 20, and so will not be described again here.

In Step S215 the UE 3 receives the indication of the new multicast MRB configuration from the base station 5. However, different from the method illustrated in FIG. 20, the UE 3 remains in the RRC connected state at this stage. Since the information indicating the new multicast configuration is received before the RRC Release occurs, step S215 may be referred to as an ‘early’ multicast configuration indication.

In step S216 the UE 3 applies the received multicast configuration and can simultaneously receive the multicast using the two DCIs (using the corresponding HARQ processes).

In step S217 the UE 3 receives the two DCIs for the multicast (e.g. DCI 4_1/4_2 and DCI 4_0).

In step S218 the UE 3 receives the multicast data using the two DCIs (using the corresponding HARQ processes). In other words, simultaneous (or near simultaneous) reception of the multicast using the two DCIs occurs.

In step S219 the DCI/HARQ switch is performed, in which the UE 3 switches to using the new multicast MRB configuration received in step S215, and no longer receives the multicast using the previous DCI configuration (corresponding to step S211).

In step S220 the base station 5 transmits the RRC release message to the UE 3, and the UE 3 subsequently transitions to the RRC inactive state. However, since the DCI/HARQ switch to the new DCI and HARQ process has already occurred, continuity of the reception of the MBS multicast is improved, and the downlink data is more reliably received and decoded at the UE 3.

Turning now to FIG. 23, in this example transport block 1 of HARQ process-1 is not successfully received and decoded by the UE 3. The UE 3 transmits a corresponding NACK, and transport block 1 is retransmitted in HARQ process-1 as illustrated in FIG. 23. The UE 3 also receives transport block 2 and transport block 3 in HARQ process-2 and HARQ process-3, respectively. After the reception of the HARQ retransmission of transport block 1, the new MRB configuration is applied at the UE 3 (corresponding to step S216 of FIG. 22). It will be appreciated that at this stage the UE 3 has already received the indication of the new multicast MRB configuration in step S215 of FIG. 22. The UE 3 can now receive transport block 4 in both HARQ process-2 and the new HARQ process (configured in step S215). Advantageously, even if there is a delay in the configuration of the new HARQ process that would result in transport block 4 not being received using the new HARQ process, transport block 4 can still be received using the existing HARQ process-2. Following the reception of transport block 4, the DCI/HARQ switch of step 219 occurs, and the UE 3 then enters the RRC inactive state (after receiving the RRC release message in step S220 of FIG. 22). The UE 3 then proceeds to receive transport blocks 5 to 9 using the newly configured HARQ process. However, since the new HARQ process has already been configured before the switch to the RRC inactive mode, the situation illustrated in FIG. 21 in which some transport blocks are not received is advantageously avoided. Depending on the timing of the HARQ/DCI switch of Step 219 it will be appreciated that in the example illustrated in FIG. 23, transport block 5 may be received by the UE 3 in both HARQ process-3 and the new HARQ process for the RRC inactive state, or may only be received by the UE 3 in the new HARQ process (but transport bock 5 is advantageously received in at least one of the HARQ processes).

### RRC Release

An improved method including an RRC release procedure will now be described. In this example, when the UE 3 is in the RRC connected state, the multicast MRB is configured as a DL-only RLC-UM entity for PTM transmission.

In order to achieve improved continuity for the MBS multicast when a transition from the RRC connected state to the RRC inactive state occurs, the multicast MRB used when the UE 3 is in the RRC connected state is not suspended. Advantageously, the UE multicast MRB is kept during the transition to the RRC inactive state, improving the continuity of the MBS multicast. The PDCP entity and the RLC entity of the multicast MRB at the UE 3 continue to run during the transition (for example, a count value, such as a count value for ‘RX_NEXT’ and ‘RX_DELIV’ of the PDCP, continues to run). A t-reordering timer of the PDCP also continues to run (the t-reordering timer is used to detect loss of PDCP Data PDUs).

In this example, when the UE 3 is in the connected state the multicast MRB may be configured as:
a multicast MRB with bidirectional RLC-UM configuration for PTP transmission;
a multicast MRB with RLC-AM entity configuration for PTP transmission;
a multicast MRB with two RLC-UM entities, one DL only RLC-UM entity for PTP transmission and one DL only RLC-UM entity for PTM transmission;
a multicast MRB with three RLC-UM entities, one DL RLC-UM entity and one UL RLC-UM entity for PTP transmission, and one DL only RLC-UM entity for PTM transmission; or
a multicast MRB with two RLC entities, one RLC-AM entity for PTP transmission and one DL only RLC-UM entity for PTM transmission.

Before the transition from the RRC connected state to the RRC inactive state, the UE 3 switches the multicast MRB bearer type to RLC-UM entity based PTM transmission (before the UE 3 is released, for example using an RRC release message). The PTP reception leg of the UE 3 for the multicast MRB is terminated before the transition to the RRC inactive state. The UE 3 multicast MRB is kept during the transition; the PDCP entity and RLC entity of the multicast MRB at the UE 3 continue to run (as described above).

### RRC Resume

An improved method including an RRC resume procedure will now be described. In this example, the UE 3 receives the multicast service when the UE 3 is in the inactive state via a PTM transmission. The UE 3 monitors the group scheduled PDDCH over a common frequency resource (CFR) for multicast. The multicast MRB is configured as a DL only RLC-UM entity for PTM transmission.

If the GC-PDSCH used for UEs 3 in the RRC connected state is the same as the GC-PDSCH used for UEs 3 in the RRC inactive state, then the UE 3 continues to use the DL HARQ process (as it is used when the UE 3 is in the RRC inactive state) for the multicast reception. The buffer (e.g. soft buffer) for receiving the data corresponding to the DL HARQ process can be maintained (not flushed) when the UE 3 is monitoring the new DCI to receive the multicast during the transition to the RRC connected state. The UE 3 multicast MRB is maintained (there is no new MRB establishment) during the transition from the RRC inactive state to the RRC connected state. Advantageously, therefore, continuity of the MBS multicast during the transition is improved. Since the multicast MRB is maintained, the PDCP and RLC entity of the multicast MRB at the UE 3 continue to run (for example, a count value, such as a count value for ‘RX_NEXT’ and ‘RX_DELIV’ of the PDCP, continues to run). A t-reordering timer of the PDCP also continues to run (the t-reordering timer is used to detect loss of PDCP Data PDUs).

Alternatively, if the GC-PDSCH used for UEs 3 in the RRC connected state is not the same as the GC-PDSCH used for UEs 3 in the RRC inactive state, then a new set of DL HARQ processes are used to continue the reception of the multicast at the UE 3. The DL HARQ process used when the UE 3 is in the RRC inactive state for multicast PTM reception is released, and the corresponding HARQ soft buffer is flushed until the UE 3 can receive the new configured GC-PDSCH via the new DCI for when the UE 3 is in the RRC connected state. Alternatively, simultaneous reception of the two GC-PDSCHs can also be performed by the UE 3. In this case, only one copy of a transport block (received via both GC-PDSCH) is delivered to the MAC layer after decoding at the physical layer (alternatively, duplicate transport blocks could be dealt with using suitable L2 processing). The multicast MRB is maintained at the UE 3 during the transition from the RRC inactive state to the RRC connected state. The PDCP entity and RLC entity continue to run, as described above for the case in which the GC-PDSCH used for UEs 3 in the RRC connected state is the same as the GC-PDSCH used for UEs 3 in the RRC inactive state.

### User Equipment

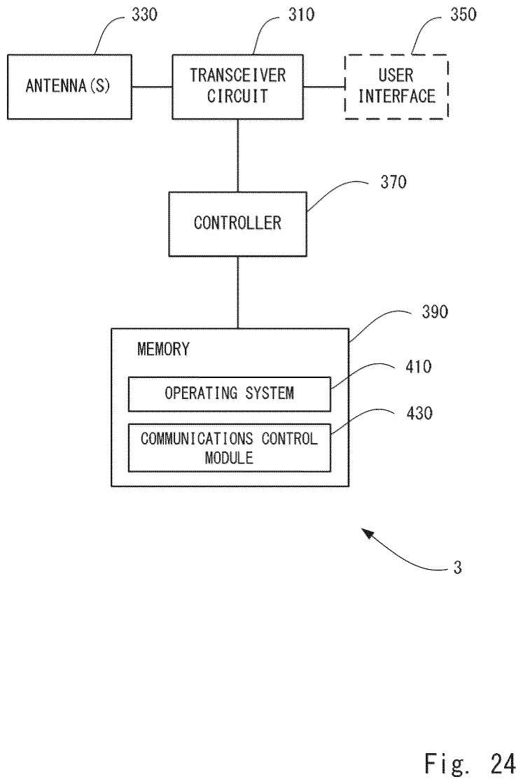

FIG. 24 is a schematic block diagram illustrating the main components of a UE 3 as shown in FIG. 1.

As shown, the UE 3 has a transceiver circuit 310 that is operable to transmit signals to and to receive signals from a base station 5 via one or more antenna 330 (e.g., comprising one or more antenna elements). The UE 3 has a controller 370 to control the operation of the UE 3. The controller 370 is associated with a memory 390 and is coupled to the transceiver circuit 310. Although not necessarily required for its operation, the UE 3 might, of course, have all the usual functionality of a conventional UE 3 (e.g. a user interface 350, such as a touch screen/keypad/microphone/speaker and/or the like for, allowing direct control by and interaction with a user) and this may be provided by any one or any combination of hardware, software, and firmware, as appropriate. Software may be pre-installed in the memory 390 and/or may be downloaded via the telecommunications network or from a removable data storage device (RMD), for example.

The controller 370 is configured to control overall operation of the UE 3 by, in this example, program instructions or software instructions stored within memory 390. As shown, these software instructions include, among other things, an operating system 410, and a communications control module 430.

The communications control module 430 is operable to control the communication between the UE 3 and its one or more serving base stations 5 (and other communication devices connected to the base station 5, such as further UEs and/or core network nodes). The communications control module 430 is configured for the overall handling uplink communications via associated uplink channels (e.g. via a physical uplink control channel (PUCCH), random access channel (RACH), and/or a physical uplink shared channel (PUSCH)) including both dynamic and semi-static signalling (e.g., SRS). The communications control module 430 is also configured for the overall handling of receipt of downlink communications via associated downlink channels (e.g. via a physical downlink control channel (PDCCH) and/or a physical downlink shared channel (PDSCH)) including both dynamic and semi-static signalling (e.g., CSI-RS). The communications control module 430 is responsible, for example: for determining where to monitor for downlink control information (e.g., the location of CSSs/USSs, CORESETs, and associated PDCCH candidates to monitor); for determining the resources to be used by the UE 3 for transmission/reception of UL/DL communications (including interleaved resources and resources subject to frequency hopping); for managing frequency hopping at the UE side; for determining how slots/symbols are configured (e.g., for UL, DL or SBFD communication, or the like); for determining which one or more bandwidth parts are configured for the UE 3; for determining how uplink transmissions should be encoded; for applying any SBFD specific communication configurations appropriately; and the like. The communications control module 430 may be configured to control communications in accordance with any of the methods described above (for example, to receive a multicast transmission from a base station 5, or to transmit HARQ feedback to the base station 5).

### Base Station

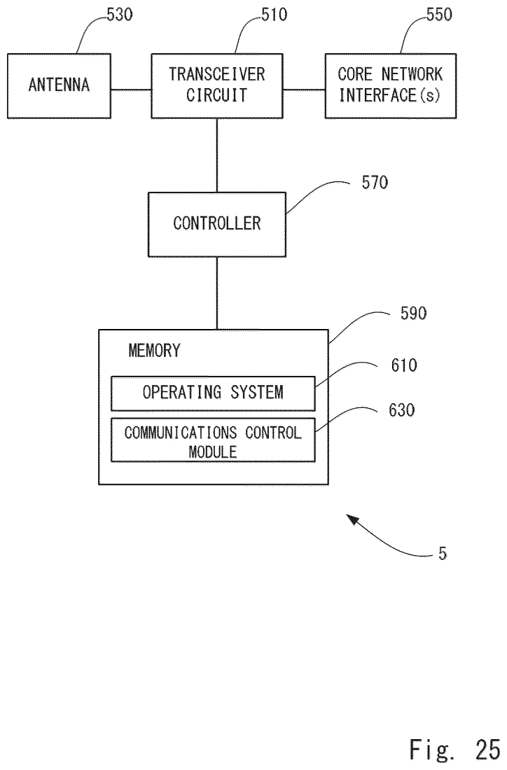

FIG. 25 is a schematic block diagram illustrating the main components of the base station 5 for the communication system 1 shown in FIG. 1. As shown, the base station 5 has a transceiver circuit 510 for transmitting signals to and for receiving signals from the communication devices (such as UEs 3) via one or more antenna 530 (e.g. a single or multi-panel antenna array/massive antenna), and a core network interface 550 (e.g. comprising the N2, N3 and other reference points/interfaces) for transmitting signals to and for receiving signals from network nodes in the core network 7. Although not shown, the base station 5 may also be coupled to other base stations via an appropriate interface (e.g. the so-called ‘Xn’ interface in NR). The base station 5 has a controller 570 to control the operation of the base station 5. The controller 570 is associated with a memory 590. Software may be pre-installed in the memory 590 and/or may be downloaded via the communication system 1 or from a removable data storage device (RMD), for example. The controller 570 is configured to control the overall operation of the base station 5 by, in this example, program instructions or software instructions stored within memory 590.

As shown, these software instructions include, among other things, an operating system 610 and a communications control module 630.

The communications control module 630 is operable to control the communication between the base station 5 and UEs 3 and other network entities that are connected to the base station 5. The communications control module 630 is configured for the overall control of the reception and decoding of uplink communications, via associated uplink channels (e.g. via a physical uplink control channel (PUCCH), a random-access channel (RACH), and/or a physical uplink shared channel (PUSCH)) including both dynamic and semi-static signalling (e.g., SRS). The communications control module 630 is also configured for the overall handling the transmission of downlink communications via associated downlink channels (e.g. via a physical downlink control channel (PDCCH) and/or a physical downlink shared channel (PDSCH)) including both dynamic and semi-static signalling (e.g., CSI-RS). The communications control module 630 is responsible for managing full duplex (e.g., SBFD) communication including, where appropriate, the segregation of UL and DL communication via different physical antenna elements. The communications control module 630 is responsible, for example: for determining where to configure the UE 3 to monitor for downlink control information (e.g., the location of CSSs/USSs, CORESETs, and associated PDCCH candidates to monitor); for determining the resources to be scheduled for UE transmission/reception of UL/DL communications (including interleaved resources and resources subject to frequency hopping); for managing frequency hopping at the base station side; for configuring slots/symbols appropriately (e.g., for UL, DL or SBFD communication, or the like); for configuring one or more bandwidth parts for the UE 3; for providing related configuration signalling to the UE 3; and the like. The communications control module 630 may be configured to control communications in accordance with any of the methods described above (for example, to transmit a multicast transmission, or to receive HARQ feedback from a UE 3).

### Modifications and Alternatives

As those skilled in the art will appreciate, a number of modifications and alternatives can be made to the above example embodiments whilst still benefiting from the disclosure embodied therein.

Whilst FIGS. 19 to 23 have been described with reference to transport blocks, a transport block may also be referred to as a “unit of data”, and it will be appreciated that the corresponding methods may also be applied to any other suitable unit of data transmission.

It will be appreciated, for example, that whilst cellular communication generation (2G, 3G, 4G, 5G, 6G etc.) specific terminology may be used, in the interests of clarity, to refer to specific communication entities, the technical features described for a given entity are not limited to devices of that specific communication generation. The technical features may be implemented in any functionally equivalent communication entity regardless of any differences in the terminology used to refer to them.

In the above description, the UEs and the base station are described for ease of understanding as having a number of discrete functional components or modules. Whilst these modules may be provided in this way for certain applications, for example where an existing system has been modified to implement the example embodiments of the disclosure, in other applications, for example in systems designed with the inventive features in mind from the outset, these modules may be built into the overall operating system or code and so these modules may not be discernible as discrete entities.

In the above example embodiments, a number of software modules were described. As those skilled in the art will appreciate, the software modules may be provided in compiled or un-compiled form and may be supplied as a signal over a computer network, or on a recording medium. Further, the functionality performed by part, or all of this software may be performed using one or more dedicated hardware circuits. However, the use of software modules is preferred as it facilitates the updating of the base station or the UE in order to update their functionalities.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like. Various other modifications will be apparent to those skilled in the art and will not be described in further detail here.

The base station may comprise a ‘distributed’ base station having a central unit ‘CU’ and one or more separate distributed units (DUs).

The User Equipment (or “UE”, “mobile station”, “mobile device” or “wireless device”) in the present disclosure is an entity connected to a network via a wireless interface.

It should be noted that the present disclosure is not limited to a dedicated communication device and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.). A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyser, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory. It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table. This list is not exhaustive and is intended to be indicative of some examples of machine type communication applications.

| Service Area | MTC applications |
|---|---|
| Security | Surveillance systems |
| | Backup for landline |
| | Control of physical access (e.g. to buildings) |
| | Car/driver security |
| Tracking & | Fleet Management |
| Tracing | Order Management |
| | Pay as you drive |
| | Asset Tracking |
| | Navigation |
| | Traffic Information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote Maintenance/ | Sensors |
| Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an MVNO (Mobile Virtual Network Operator) service, an emergency radio communication system, a PBX (Private Branch eXchange) system, a PHS/Digital Cordless Telecommunications system, a POS (Point of sale) system, an advertise calling system, an MBMS (Multimedia Broadcast and Multicast Service), a V2X (Vehicle to Everything) system, a train radio system, a location related service, a Disaster/Emergency Wireless Communication Service, a community service, a video streaming service, a femto cell application service, a VoLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and example embodiments described in the present document. Needless to say, these technical ideas and example embodiments are not limited to the above-described UE and various modifications can be made thereto.

Various other modifications will be apparent to those skilled in the art and will not be described in further detail here.

For example, the whole or part of the example embodiments disclosed above can be described as, but not limited to, the following supplementary notes.

### (Supplementary Note 1)

A method of a user equipment, UE, the method comprising:
receiving data of a multicast, from an access network node, using a repeat request process when the UE is in a radio resource control, RRC, connected state;
transitioning into an RRC inactive state; and
receiving data of the multicast, from the access network node, when the UE is in the RRC inactive state;
wherein the UE uses the same repeat request process used to receive data of the multicast in the RRC connected state to receive data of the multicast when the UE is in the RRC inactive state.

### (Supplementary Note 2)

The method according to supplementary note 1, wherein the UE maintains received data of the multicast in a buffer associated with the repeat request process during a transition from the RRC connected state to the RRC inactive state.

### (Supplementary Note 3)

The method according to supplementary note 1 or 2, wherein the method further comprises receiving, from the access network node, downlink control information for receiving data of the multicast, wherein the downlink control information includes a repeat request configuration for the repeat request process.

### (Supplementary Note 4)

The method according to any one of supplementary notes 1 to 3, wherein the repeat request process is a hybrid automatic repeat request, HARQ, process.

### (Supplementary Note 5)

The method according to any one of supplementary notes 1 to 4, wherein the UE uses the repeat request process for reception of data of the multicast, but does not request retransmission, when the UE is in the RRC inactive state.

### (Supplementary Note 6)

The method according to any one of supplementary notes 1 to 5, wherein the UE uses a single repeat request process to receive data of the multicast when the UE is in the RRC connected state and when the UE is in the RRC inactive state.

### (Supplementary Note 7)

The method according to supplementary note 6, wherein when the UE is in the RRC inactive state, the UE attempts to decode each unit of data received using the repeat request process, irrespective of whether that unit of data is retransmitted data or newly transmitted data; and
wherein the UE determines whether that unit of data is retransmitted data or newly transmitted data after the unit of data has been decoded at the UE.

### (Supplementary Note 8)

The method according to any one of supplementary notes 1 to 5, wherein the method further comprises:
receiving, from the access network node, for a plurality of repeat request processes, scheduling information for requesting retransmission of data of the multicast when the UE is in a radio resource control, RRC, connected state;
wherein receiving data of the multicast from the access network node when the UE is in the RRC connected state comprises receiving the data of the multicast using the plurality of repeat request processes; and
wherein the UE uses the same plurality of repeat request process used to receive the data of the multicast in the RRC connected state to receive data of the multicast when the UE has transitioned into the RRC inactive state from the RRC connected state.

### (Supplementary Note 9)

The method according to supplementary note 8, wherein the scheduling information includes at least one of an indication of an identity of a repeat request process of the plurality of repeat request processes, and an indication of whether data transmitted to the UE using a repeat request process of the plurality of repeat request processes is newly transmitted data or retransmitted data.

### (Supplementary Note 10)

The method according to supplementary note 8 or 9, wherein the method further comprises decoding retransmitted data of the multicast, received from the access network node using one the plurality of repeat request processes when in the RRC inactive state, if the same data has not already been decoded at the UE.

### (Supplementary Note 11)

The method according to any one of supplementary notes 8 to 10, wherein the method further comprises not decoding retransmitted data of the multicast, received using one the plurality of repeat request processes when in the RRC inactive state, if the UE determines that the data of the multicast has already been decoded at the UE.

### (Supplementary Note 12)

A method of a user equipment, UE, the method comprising:
receiving first data of a multicast, from an access network node, using a first repeat request process when the UE is in a radio resource control, RRC, connected state;
transitioning into an RRC inactive state; and
receiving second data of the multicast from the access network node, using a second repeat request process when the UE is in a radio resource control, RRC, connected state;
wherein the method comprises at least one of:
receiving the first data of the multicast using the first repeat request process and a first set of at least one time resource, and the second repeat request process and a second set of at least one time resource when the UE is in the RRC connected state; and
receiving the second data of the multicast using both the first repeat request process and the first set of at least one time resource, and the second repeat request process and the second set of at least one time resource when the UE is in the RRC inactive state;
wherein the first set of at least one time resource is configured by the access network node to at least partially overlap with the second set of at least one time resource.

### (Supplementary Note 13)

A method of a user equipment, UE, the method comprising:
receiving data of a multicast, from an access network node, using a plurality of first repeat request processes when the UE is in a radio resource control, RRC, connected state;
receiving, from the access network node, an RRC release message that indicates that the UE is to transition into an RRC inactive state, wherein the RRC release message includes multicast configuration information for a second repeat request process;
releasing, based on the multicast configuration information, the plurality of first repeat request processes; and
receiving data of the multicast from the access network node using the second repeat request process when the UE is in the RRC inactive state.

### (Supplementary Note 14)

The method according to supplementary note 13, wherein the method further comprises:
receiving first downlink control information for reception of data of the multicast using the plurality of first repeat request processes; and
receiving second downlink control information for reception of data of the multicast using the second repeat request process;
wherein a format or type of the first downlink control information is different from a format or type of the second downlink control information.

### (Supplementary Note 15)

The method according to supplementary note 14, wherein the UE determines to release the plurality of first repeat request processes based on at least one of:
a difference between the format or type of the first downlink control information and the format or type of the second downlink control information; and
an indication in the multicast configuration information that a single repeat request process is to be used to receive data of the multicast when the UE is in the RRC inactive state.

### (Supplementary Note 16)

A method of a user equipment, UE, the method comprising:
receiving data of a multicast from an access network node using a plurality of first repeat request processes when the UE is in a radio resource control, RRC, connected state;
receiving, from the access network node, when the UE is in the RRC connected state, multicast configuration information for a second repeat request process for
receiving data of the multicast when the UE is in the RRC inactive state;
receiving data of the multicast from the access network node, when the UE is in the RRC connected state, using the plurality of first repeat request processes and using the second repeat request process;
receiving, from the access network node, an RRC release message that indicates that the UE is to transition into an RRC inactive state;
transitioning into the RRC inactive state; and
receiving data of the multicast from the access network node using the second repeat request process when the UE is in the RRC inactive state.

### (Supplementary Note 17)

The method according to supplementary note 16, wherein the method further comprises:
receiving first downlink control information for reception of data of the multicast using the plurality of first repeat request processes; and
receiving second downlink control information for reception of data of the multicast using the second repeat request process;
wherein a format or type of the first downlink control information is different from a format or type of the second downlink control information.

### (Supplementary Note 18)

A method of a user equipment, UE, the method comprising:
receiving data of a multicast from an access network node using at least one multicast radio bearer, MRB, when the UE is in a radio resource control, RRC, connected state;
transitioning into an RRC inactive state;
receiving data of the multicast from the access network node using the MRB when the UE is in the RRC inactive state;
wherein a radio link control, RLC, entity at the UE that is associated with the MRB when the UE is in the RRC connected state is maintained at the UE as the UE transitions into the RRC inactive state.

### (Supplementary Note 19)

The method according to supplementary note 18, wherein at least one of a count value or timer for the MRB stored at the UE when the UE is in the RRC connected state is maintained at the UE as the UE transitions into the RRC inactive state.

### (Supplementary Note 20)

The method according to supplementary note 18 or 19, wherein the method comprises switching, before the UE transitions into the RRC inactive state, the RLC entity from a first mode for transmission of repeat request feedback to the access network node, to a second mode in which repeat request feedback is not transmitted to the access network node.

### (Supplementary Note 21)

A method of a user equipment, UE, the method comprising:
receiving data of a multicast from an access network node using at least one multicast radio bearer, MRB, when the UE is in a radio resource control, RRC, inactive state, wherein the UE uses a repeat request process to receive data of the multicast;
transitioning into an RRC connected state; and
receiving data of the multicast from the access network node using the MRB, when the UE is in the RRC connected state, and using the MRB and the repeat request process used to receive data of the multicast when the UE was in the RRC inactive state.

### (Supplementary Note 22)

The method according to supplementary note 21, wherein data of the multicast stored in a buffer associated with the repeat request process when the UE is in the RRC inactive state is maintained in the buffer as the UE transitions into the RRC connected state.

### (Supplementary Note 23)

The method according to supplementary note 21 or 22, wherein a radio link control, RLC, entity at the UE that is associated with the MRB when the UE is in the RRC inactive state remains is maintained at the UE as the UE transitions into the RRC inactive state.

### (Supplementary Note 24)

A method of a user equipment, UE, the method comprising:
receiving data of a multicast from an access network node using at least one multicast radio bearer, MRB, when the UE is in a radio resource control, RRC, inactive state, wherein the UE uses a first repeat request process to receive data of the multicast;
transitioning into an RRC connected state; and
receiving data of the multicast from the access network node using the MRB, when the UE is in the RRC connected state, using the MRB used to receive the multicast when the UE was in the RRC inactive state, and using a plurality of second repeat request processes, different from the first repeat request process.

### (Supplementary Note 25)

The method according to supplementary note 24, wherein a radio link control, RLC, entity at the UE that is associated with the MRB when the UE is in the RRC inactive state remains is maintained at the UE as the UE transitions into the RRC inactive state.

### (Supplementary Note 26)

A method of an access network node, the method comprising:
transmitting data of a multicast to a user equipment, UE, using a repeat request process, when the UE is in a radio resource control, RRC, connected state; and
transmitting data of the multicast to the UE, using the same repeat request process, when the UE is in a radio resource control, RRC, inactive state.

### (Supplementary Note 27)

A method of an access network node, the method comprising:
transmitting data of a multicast to a first user equipment, UE, using a first repeat request process and using a first set of at least one time resource, when the first UE is in a radio resource control, RRC, connected state; and
transmitting the data of the multicast to a second UE, using a second repeat request process and using a second set of at least one time resource, when the second UE is in an RRC inactive state;
wherein the first set of at least one time resource is configured by the access network node to at least partially overlap in time with the second set of at least one time resource.

### (Supplementary Note 28)

The method according to supplementary note 27, wherein the first set of at least one time resource is the same as the second set of at least one time resource.

### (Supplementary Note 29)

The method according to supplementary note 27 or 28, wherein the method further comprises:
receiving, from the first UE, a request for retransmission of data of the multicast using the first repeat request process; and
retransmitting the data of the multicast using the first repeat request process and using a third set of at least one time resource, and not transmitting the retransmission of the multicast data using the second repeat request process and the third set of at least one time resource.

### (Supplementary Note 30)

A method of an access network node, the method comprising:
transmitting data of a multicast, to a user equipment, UE, using a plurality of first repeat request processes when the UE is in a radio resource control, RRC, connected state;
transmitting, to the UE, an RRC release message that indicates that the UE is to transition into an RRC inactive state, wherein the RRC release message includes multicast configuration information for a second repeat request process, wherein the multicast configuration information indicates that the UE is to release the plurality of first repeat request processes; and
transmitting data of the multicast to the UE using the second repeat request process when the UE is in the RRC inactive state.

### (Supplementary Note 31)

A method of an access network node, the method comprising:
transmitting data of a multicast to a user equipment, UE, using a plurality of first repeat request processes when the UE is in a radio resource control, RRC, connected state;
transmitting, to the UE, when the UE is in the RRC connected state, multicast configuration information for a second repeat request process for receiving data of the multicast when the UE is in the RRC inactive state;
transmitting data of the multicast to the UE, when the UE is in the RRC connected state, using the plurality of first repeat request processes and using the second repeat request process;
transmitting, to the UE, an RRC release message that indicates that the UE is to transition into an RRC inactive state; and
transmitting data of the multicast to the UE using the second repeat request process when the UE is in the RRC inactive state.

### (Supplementary Note 32)

A user equipment, UE, comprising:
means for receiving data of a multicast, from an access network node, using a repeat request process when the UE is in a radio resource control, RRC, connected state; and
means for transitioning into an RRC inactive state;
wherein the means for receiving is configured for receiving data of the multicast, from the access network node, when the UE is in the RRC inactive state; and
wherein the UE is configured to use the same repeat request process used to receive data of the multicast in the RRC connected state to receive data of the multicast when the UE is in the RRC inactive state.

### (Supplementary Note 33)

A user equipment, UE, comprising:
means for receiving first data of a multicast, from an access network node, using a first repeat request process when the UE is in a radio resource control, RRC, connected state; and
means for transitioning into an RRC inactive state;
wherein the means for receiving is configured for receiving second data of the multicast from the access network node, using a second repeat request process when the UE is in a radio resource control, RRC, connected state;
and wherein the means for receiving is configured for at least one of:
receiving the first data of the multicast using the first repeat request process and a first set of at least one time resource, and the second repeat request process and a second set of at least one time resource when the UE is in the RRC connected state; and
receiving the second data of the multicast using both the first repeat request process and the first set of at least one time resource, and the second repeat request process and the second set of at least one time resource when the UE is in the RRC inactive state;
wherein the first set of at least one time resource is configured by the access network node to at least partially overlap with the second set of at least one time resource.

### (Supplementary Note 34)

A user equipment, UE, comprising:
means for receiving data of a multicast, from an access network node, using a plurality of first repeat request processes when the UE is in a radio resource control, RRC, connected state, and for receiving, from the access network node, an RRC release message that indicates that the UE is to transition into an RRC inactive state, wherein the RRC release message includes multicast configuration information for a second repeat request process; and
means for releasing, based on the multicast configuration information, the plurality of first repeat request processes;
wherein the means for receiving is configured for data of the multicast from the access network node using the second repeat request process when the UE is in the RRC inactive state.

### (Supplementary Note 35)

A user equipment, UE, comprising:
means for receiving configured for:
receiving data of a multicast from an access network node using a plurality of first repeat request processes when the UE is in a radio resource control, RRC, connected state;
receiving, from the access network node, when the UE is in the RRC connected state, multicast configuration information for a second repeat request process for receiving data of the multicast when the UE is in the RRC inactive state;
receiving data of the multicast from the access network node, when the UE is in the RRC connected state, using the plurality of first repeat request processes and using the second repeat request process; and
receiving, from the access network node, an RRC release message that indicates that the UE is to transition into an RRC inactive state; and
means for transitioning into the RRC inactive state;
wherein the means for receiving is further configured for receiving data of the multicast from the access network node using the second repeat request process when the UE is in the RRC inactive state.

### (Supplementary Note 36)

A user equipment, UE, comprising:
means for receiving data of a multicast from an access network node using at least one multicast radio bearer, MRB, when the UE is in a radio resource control, RRC, connected state; and
means for transitioning into an RRC inactive state;
wherein the means for receiving is configured for receiving data of the multicast from the access network node using the MRB when the UE is in the RRC inactive state; and
wherein the UE is configured to maintain a radio link control, RLC, entity at the UE that is associated with the MRB when the UE is in the RRC connected state, as the UE transitions into the RRC inactive state.

### (Supplementary Note 37)

A user equipment, UE, comprising:
means for receiving data of a multicast from an access network node using at least one multicast radio bearer, MRB, when the UE is in a radio resource control, RRC, inactive state, wherein the UE is configured to use a repeat request process to receive data of the multicast; and
means for transitioning into an RRC connected state;
wherein the means for receiving is configured for receiving data of the multicast from the access network node using the MRB, when the UE is in the RRC connected state, and using the MRB and the repeat request process used to receive data of the multicast when the UE was in the RRC inactive state.

### (Supplementary Note 38)

A user equipment, UE, comprising:
means for receiving data of a multicast from an access network node using at least one multicast radio bearer, MRB, when the UE is in a radio resource control, RRC, inactive state, wherein the UE is configured to use a first repeat request process to receive data of the multicast; and
means for transitioning into an RRC connected state;
wherein the means for receiving is configured for receiving data of the multicast from the access network node using the MRB, when the UE is in the RRC connected state, using the MRB used to receive the multicast when the UE was in the RRC inactive state, and using a plurality of second repeat request processes, different from the first repeat request process.

### (Supplementary Note 39)

An access network node comprising:
means for transmitting data of a multicast to a user equipment, UE, using a repeat request process, when the UE is in a radio resource control, RRC, connected state;
wherein the means for transmitting is configured for transmitting data of the multicast to the UE, using the same repeat request process, when the UE is in a radio resource control, RRC, inactive state.

### (Supplementary Note 40)

An access network node comprising:
means for transmitting data of a multicast to a first user equipment, UE, using a first repeat request process and using a first set of at least one time resource, when the first UE is in a radio resource control, RRC, connected state;
wherein the means for transmitting is configured for transmitting the data of the multicast to a second UE, using a second repeat request process and using a second set of at least one time resource, when the second UE is in an RRC inactive state; and
wherein the access network node further comprises means for configuring the first set of at least one time resource to at least partially overlap in time with the second set of at least one time resource.

### (Supplementary Note 41)

An access network node comprising:
means for transmitting configured for:
transmitting data of a multicast, to a user equipment, UE, using a plurality of first repeat request processes when the UE is in a radio resource control, RRC, connected state;
transmitting, to the UE, an RRC release message that indicates that the UE is to transition into an RRC inactive state, wherein the RRC release message includes multicast configuration information for a second repeat request process, wherein the multicast configuration information indicates that the UE is to release the plurality of first repeat request processes; and
transmitting data of the multicast to the UE using the second repeat request process when the UE is in the RRC inactive state.

### (Supplementary Note 42)

An access network node comprising:
means for transmitting configured for:
transmitting data of a multicast to a user equipment, UE, using a plurality of first repeat request processes when the UE is in a radio resource control, RRC, connected state;
transmitting, to the UE, when the UE is in the RRC connected state, multicast configuration information for a second repeat request process for receiving data of the multicast when the UE is in the RRC inactive state;
transmitting data of the multicast to the UE, when the UE is in the RRC connected state, using the plurality of first repeat request processes and using the second repeat request process;
transmitting, to the UE, an RRC release message that indicates that the UE is to transition into an RRC inactive state; and
transmitting data of the multicast to the UE using the second repeat request process when the UE is in the RRC inactive state.

This application is based upon and claims the benefit of priority from Great Britain Patent Application No. 2301029.1, filed on Jan. 14, 2023, the disclosure of which is incorporated herein in its entirety by reference.

### REFERENCE SIGNS LIST

1 COMMUNICATION SYSTEM
3 USER EQUIPMENT
5 BASE STATION
7 CORE NETWORK
9 CELL
10 COMPRISES CONTROL PLANE FUNCTIONS
11 USER PLANE FUNCTIONS
50 DU
60 CU
310 TRANSCEIVER CIRCUIT
330 ANTENNA
350 USER INTERFACE
370 CONTROLLER
390 MEMORY
410 OPERATING SYSTEM
430 COMMUNICATIONS CONTROL MODULE
510 TRANSCEIVER CIRCUIT
530 ANTENNA
550 CORE NETWORK INTERFACE
570 CONTROLLER
590 MEMORY
610 OPERATING SYSTEM
630 COMMUNICATIONS CONTROL MODULE

What is claimed is:

1-26. (canceled)

27. A method performed by a mobile device, the method comprising:
keeping, with an access network node, a service continuity for multicast reception by using a multicast radio bearer (MRB) configured as downlink (DL) only Radio Link Control-Unacknowledge Mode (RLC-UM) entity for point-to-multipoint (PTM) transmission during transition between a Radio Resource Control (RRC) inactive state and a RRC connected state, wherein
a Protocol Data Convergence Protocol (PDCP) count value on the mobile device corresponding to the MRB is maintained during the transition between the RRC inactive state and the RRC connected state.

28. The method according to claim 27, further comprising:
resuming to transit from the RRC inactive state to the RRC connected state upon reception of a group notification.

29. The method according to claim 27, wherein
the keeping the service continuity includes at least one of:
keeping the MRB configured as DL only RLC-UM entity for PTM transmission during the transition between the RRC inactive state and the RRC connected state, or
switching a type of the MRB to DL only RLC-UM entity for PTM transmission before the transition between the RRC inactive state and the RRC connected state.

30. The method according to claim 27, wherein
a RLC entity on the mobile device corresponding to the MRB is maintained during the transition between the RRC inactive state and the RRC connected state.

31. The method according to claim 27, further comprising:
using at least one repeat request process for receiving data of multicast during the RRC connected state, the at least one repeat request process being used for receiving data of multicast during the RRC inactive state.

32. The method according to claim 31, wherein
the data of the multicast stored in a buffer corresponding to the at least one repeat request process before the transition between the RRC inactive state and the RRC connected state is maintained in the buffer during the transition between the RRC inactive state and the RRC connected state.

33. The method according to claim 31, further comprising:
receiving control information for scheduling group common multicast transmission in the RRC inactive state and the RRC connected state, wherein
the control information does not include scheduling information for the at least one repeat request process, and
the at least one repeat request process is for a single process to receive multicast transmission.

34. The method according to claim 31, further comprising:
receiving a control information for scheduling group common multicast transmission in the RRC inactive state and the RRC connected state, wherein
the control information includes scheduling information for the at least one repeat request process,
the at least one repeat request process includes multiple processes to receive multicast transmission, and
the scheduling information is ignored during the RRC inactive state.

35. The method according to claim 31, wherein
receiving a control information for scheduling group common multicast transmission in the RRC inactive state and the RRC connected state, wherein
the control information includes scheduling information for the at least one repeat request process,
the at least one repeat request process includes multiple processes to receive multicast transmission, and
one of the multiple processes is used during the RRC inactive process.

36. The method according to claim 27, further comprising:
using at least one first repeat request process for receiving data of multicast during the RRC inactive state; and
using at least one second repeat request process for receiving data of multicast during the RRC connected state, wherein
the at least one second repeat request process is different from the at least one first repeat request process.

37. The method according to claim 36, wherein
the at least one first repeat request process is released upon the transition between the RRC inactive state and the RRC connected state, and
data of the multicast stored in a buffer corresponding to the at least one first repeat request process before the transition between the RRC inactive state and the RRC connected state is flushed upon the transition between the RRC inactive state and the RRC connected state.

38. The method according to claim 36, further comprising:
receiving first control information for scheduling group common multicast transmission in the RRC inactive state,
receiving second control information for scheduling group common multicast transmission in the RRC connected state, wherein
a transport block is transmitted in duplicated manner by the group common transmission corresponding to the first control information and the group common transmission corresponding to the second control information.

39. The method according to claim 36, wherein
at least one of the first control information and the second control information is configured before the transition between the RRC inactive state and the RRC connected state.

40. The method according to claim 38, further comprising:
switching multicast reception between the group common transmission corresponding to the first control information and the group common transmission corresponding to the second control information, before the transition between the RRC inactive state and the RRC connected state.

41. The method according to claim 27, wherein
any transport block that was not successfully decoded due to the transition between the RRC inactive state and the RRC connected state is discarded or removed from a buffer.

42. The method according to claim 31, wherein
the at least one repeat request process includes a hybrid automatic repeat request (HARQ) process.

43. The method according to claim 27, wherein
the transition between the RRC inactive state and the RRC connected state includes at least one of:
transition from the RRC inactive state to the RRC connected state, or
transition from the RRC connected state to the RRC inactive state.

44. A method of an access network node, the method comprising:
keeping, with a mobile device, a service continuity for multicast reception by using a multicast radio bearer (MRB) configured as downlink (DL) only Radio Link Control-Unacknowledge Mode (RLC-UM) entity for point-to-multipoint (PTM) transmission during transition of the mobile device between a Radio Resource Control (RRC) inactive state and a RRC connected state, wherein
a Protocol Data Convergence Protocol (PDCP) count value on the mobile device corresponding to the MRB is maintained during the transition between the RRC inactive state and the RRC connected state.

45. A mobile device comprising:
a memory configured to store instructions; and
a processor configured to execute the instructions to keep, with an access network node, a service continuity for multicast reception by using a multicast radio bearer (MRB) configured as downlink (DL) only Radio Link Control-Unacknowledge Mode (RLC-UM) entity for point-to-multipoint (PTM) transmission during transition between a Radio Resource Control (RRC) inactive state and a RRC connected state, wherein
a Protocol Data Convergence Protocol (PDCP) count value on the mobile device corresponding to the MRB is maintained during the transition between the RRC inactive state and the RRC connected state.

46. An access network node comprising:
a memory configured to store instructions; and
a processor configured to execute the instructions to keep, with a mobile device, a service continuity for multicast reception by using a multicast radio bearer (MRB) configured as downlink (DL) only Radio Link Control-Unacknowledge Mode (RLC-UM) entity for point-to-multipoint (PTM) transmission during transition of the mobile device between a Radio Resource Control (RRC) inactivity state and a RRC connected state, wherein
a Protocol Data Convergence Protocol (PDCP) count value on the mobile device corresponding to the MRB is maintained during the transition between the RRC inactive state and the RRC connected state.
